(19) United States
(12) Patent Application Publication
(10) Pub. No.: US 2017/0024651 A1
(43) Pub. Date: Jan. 26, 2017

(54) TOPOLOGICAL DATA ANALYSIS FOR IDENTIFICATION OF MARKET REGIMES FOR PREDICTION

(71) Applicant: Ayasdi, Inc., Menlo Park, CA (US)

(72) Inventor: Anshuman Mishra, Mountain View, CA (US)

(21) Appl. No.: 15/219,172

(22) Filed: Jul. 25, 2016

Related U.S. Application Data
(60) Provisional application No. 62/196,237, filed on Jul. 23, 2015.

(51) Int. Cl. G06N 5/04; G06Q 30/02

(52) U.S. Cl. CPC G06N 5/04; G06Q 30/0202; G06Q 30/0201

(57) ABSTRACT

An example method includes receiving a data set, generating a topological representation using topological data analysis, at least one metric-lens combination, and the data set, the representation including a plurality of nodes, each of the nodes having one or more data points as members, receiving a new data point, determining distances between the new data point and at least some of the one or more data points, locating the new data point in a location relative to one or more of the nodes using the distances, identifying a subset of the data points closest to the location of the new data point, comparing the subset of the data points to at least some information regarding the new data point to identify a regime, and generating a report indicating a model associating factors associated with the subset of the data points with the new data point for predicting future outcomes.

### CROSS-REFERENCE TO RELATED APPLICATION

The present application claims the benefit of U.S. Provisional Patent Application Ser. No. 62/196,237, filed Jul. 23, 2015 and entitled “TDA Market Regime Detection,” the entirety of which is incorporated herein by reference. The present application incorporates by reference herein U.S. Nonprovisional patent application Ser. No. 13/648,237 filed Oct. 9, 2012 and entitled “Systems and methods for Mapping New Patient Information to Historic Outcomes for Treatment Assistance” as well as U.S. Nonprovisional patent application Ser. No. 14/639,954 filed Mar. 5, 2015 and entitled “Systems and methods for Capture of Relationships within Information.”

### BACKGROUND

### 1. Field of the Invention

Embodiments of the present invention(s) are directed to identification of market regimes to generate predictions based at least in part on influencing factors of the market regimes.

### 2. Related Art

As the collection and storage data has increased, there is an increased need to analyze and make sense of large amounts of data. Examples of large datasets may be found in financial services companies, oil expiration, biotech, and academia. Unfortunately, previous methods of analysis of large multidimensional datasets tend to be insufficient (if possible at all) to identify important relationships and may be computationally inefficient.

In one example, previous methods of analysis often use clustering. Clustering is often too blunt an instrument to identify important relationships in the data. Similarly, previous methods of linear regression, projection pursuit, principal component analysis, and multidimensional scaling often do not reveal important relationships. Existing linear algebraic and analytic methods are too sensitive to large scale distances and, as a result, lose detail.

Further, even if the data is analyzed, sophisticated experts are often necessary to interpret and understand the output of previous methods. Although some previous methods allow graphs depicting some relationships in the data, the graphs are not interactive and require considerable time for a team of such experts to understand the relationships. Further, the output of previous methods does not allow for exploratory data analysis where the analysis can be quickly modified to discover new relationships. Rather, previous methods require the formulation of a hypothesis before testing.

### SUMMARY OF THE INVENTION(S)

In various embodiments, a method comprises receiving a data set, generating a topological representation using the received data set and topological data analysis, the topological representation being generated using at least one metric-lens combination of a subset of metric-lens combinations, the topological representation including a plurality of nodes, each of the nodes having one or more data points from the data set as members, at least two nodes of the plurality of nodes being connected by an edge if the at least two nodes share at least one data point from the data set as members, receiving a new data point, determining distances between the new data point and at least some of the one or more data points from the data set, locating the new data point in a location relative to one or more of the nodes in the topological representation using the distances between the new data point and the at least some of the one or more data points from the data set, identifying a subset of the data points closest to the location of the new data point, comparing the subset of the data points to at least some information regarding the new data point to identify a regime associated with the new data point, and generating a report indicating a model associating factors associated with the subset of the data points with the new data point for predicting future outcomes.

In some embodiments, the topological representation is a visualization depicting the plurality of nodes and the edge. Each of the one or more data points from the data set may be identified by a date indicating a plurality of conditions associated with that date. The new data point may be associated with a new date and the subset of the data points closest to the location of the new data point include at least one similar condition of the plurality of conditions. The model may predict an outcome associated with information regarding the new data point when the least one similar condition of the plurality of conditions recurs. The distances between the new data point and the at least some of the one or more data points from the data set may be based on a metric from the at least one metric-lens combination.

In some embodiments, the distances between the new data point and the at least some of the one or more data points from the data set may be based on a graphical distance of the topological representation. The number of the subset of the data points closest to the new data point may be based on a proximity value. The proximity value is received from a digital device. In various embodiments, information associated with the new data point and the number of the subset of the data points closest to the new data point is based on a proximity value is analyzed using statistical measures to determine correlations.

An example non-transitory computer readable medium may include executable instructions. The instructions may be executable by a processor to perform a method. The method may comprise receiving a data set, generating a topological representation using the received data set and topological data analysis, the topological representation being generated using at least one metric-lens combination of a subset of metric-lens combinations, the topological representation including a plurality of nodes, each of the nodes having one or more data points from the data set as members, at least two nodes of the plurality of nodes being connected by an edge if the at least two nodes share at least one data point from the data set as members, receiving a new data point, determining distances between the new data point and at least some of the one or more data points from the data set, locating the new data point in a location relative to one or more of the nodes in the topological representation using the distances between the new data point and the at least some of the one or more data points from the data set, identifying a subset of the data points closest to the location of the new data point, comparing the subset of the data points to at least some information regarding the new data point to identify a regime associated with the new data point, and generating a report indicating a model associating factors associated with the subset of the data points with the new data point for predicting future outcomes.

An example system comprises a processor and a memory. The memory may include instructions to configure the processor to: receive a data set, generate a topological representation using the received data set and topological data analysis, the topological representation being generated using at least one metric-lens combination of a subset of metric-lens combinations, the topological representation including a plurality of nodes, each of the nodes having one or more data points from the data set as members, at least two nodes of the plurality of nodes being connected by an edge if the at least two nodes share at least one data point from the data set as members, receive a new data point, determining distances between the new data point and at least some of the one or more data points from the data set, locate the new data point in a location relative to one or more of the nodes in the topological representation using the distances between the new data point and the at least some of the one or more data points from the data set, identify a subset of the data points closest to the location of the new data point, compare the subset of the data points to at least some information regarding the new data point to identify a regime associated with the new data point, and generate a report indicating a model associating factors associated with the subset of the data points with the new data point for predicting future outcomes

### BRIEF DESCRIPTION OF THE DRAWINGS

FIG. 1A is an example graph representing data that appears to be divided into three disconnected groups.

FIG. 1B is an example graph representing data set obtained from a Lotka-Volterra equation modeling the populations of predators and prey over time.

FIG. 1C is an example graph of data sets whereby the data does not break up into disconnected groups, but instead has a structure in which there are lines (or flares) emanating from a central group.

FIG. 2 is an example environment in which embodiments may be practiced.

FIG. 3 is a block diagram of an example analysis server.

FIG. 4 is a flow chart depicting an example method of dataset analysis and visualization in some embodiments.

FIG. 5 is an example ID field selection interface window in some embodiments.

FIG. 6A is an example data field selection interface window in some embodiments.

FIG. 6B is an example metric and filter selection interface window in some embodiments.

FIG. 7 is an example filter parameter interface window in some embodiments.

FIG. 8 is a flowchart for data analysis and generating a visualization in some embodiments.

FIG. 9 is an example interactive visualization in some embodiments.

FIG. 10 is an example interactive visualization displaying an explain information window in some embodiments.

FIG. 11 is a flowchart of functionality of the interactive visualization in some embodiments.

FIG. 12 depicts a general process of forming a hypothesis and testing the hypothesis in the prior art.

FIG. 13 depicts an example analysis system in some embodiments.

FIG. 14 depicts a flow chart for generating and using a TDA graph or model to create a comparative risk profile in some embodiments.

FIG. 15 is a flowchart for generating a market regime visualization utilizing intermarket and/or macro-economic data for any periods of time in some embodiments.

FIG. 16 depicts a rows and columns of example intermarket and/or macro-economic data that the analysis server may receive.

FIG. 17 depicts an example market regime visualization in some embodiments.

FIG. 18 is a flowchart for positioning new financial data relative to a market regime visualization in some embodiments.

FIG. 19 is an example visualization displaying the market regime visualization 1700 as well as placement of the new financial data in some embodiments.

FIG. 20 is a flow chart for identifying relationships based on placement of the new financial data in the market regime visualization and generating a prediction of expected percentage loss.

FIG. 21 depicts an example of a portion of the market regime visualization with the new financial data as well as the selected nodes closest to the new financial data.

FIG. 22 is an example report indicating the found similar dates (e g, similar data points proximate to the data point(s) of the new financial data), the cumulative intraday low from the underlying data based on the similar dates for the specified forward range of days, total swingdowns for each of the specified forward range of days, and swingdown exceedance percentage.

FIG. 23 is a graph indicating portfolio allocation among equity sector ETFs depicting measures of likelihood against percent drop.

FIG. 24 is an example report of a comparative risk profile generated by the report module in some embodiments.

FIG. 25 is a flowchart for creating a forecast for new data with volume profile data for historical dates for liquidity in some embodiments.

FIG. 26 depicts the data that the analysis system will utilize for TDA analysis in some embodiments.

FIG. 27A depicts an example of an intraday normalized volume distribution.

FIG. 27B depicts a bar chart for the example intraday normalized volume distribution.

FIG. 28 is an example table indicating similar trading days that are similar to the date in the testing period (e.g. the one or more dates provided by the user).

FIG. 29 depicts a liquidity forecast model generated by the analysis system.

FIG. 30 is a block diagram of an example digital device.

### DETAILED DESCRIPTION OF THE DRAWINGS

Some embodiments described herein may be a part of the subject of Topological Data Analysis (TDA). TDA is an area of research which has produced methods for studying point cloud data sets from a geometric point of view. Other data analysis techniques use “approximation by models” of various types. For example, regression methods model the data as the graph of a function in one or more variables. Unfortunately, certain qualitative properties (which one can readily observe when the data is two-dimensional) may be of a great deal of importance for understanding, and these features may not be readily represented within such models.

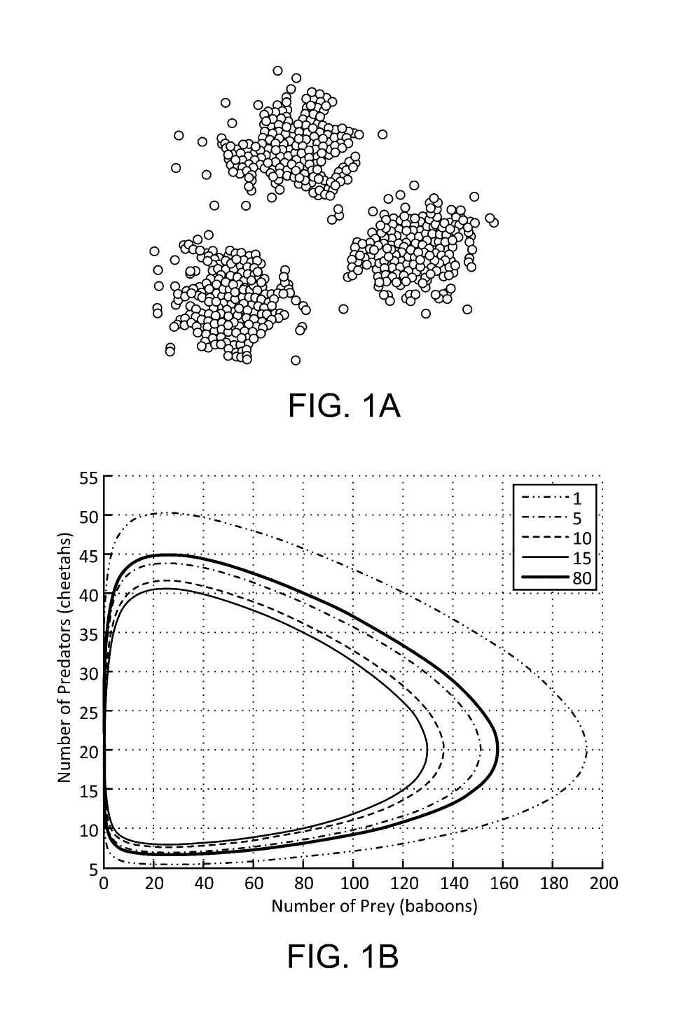

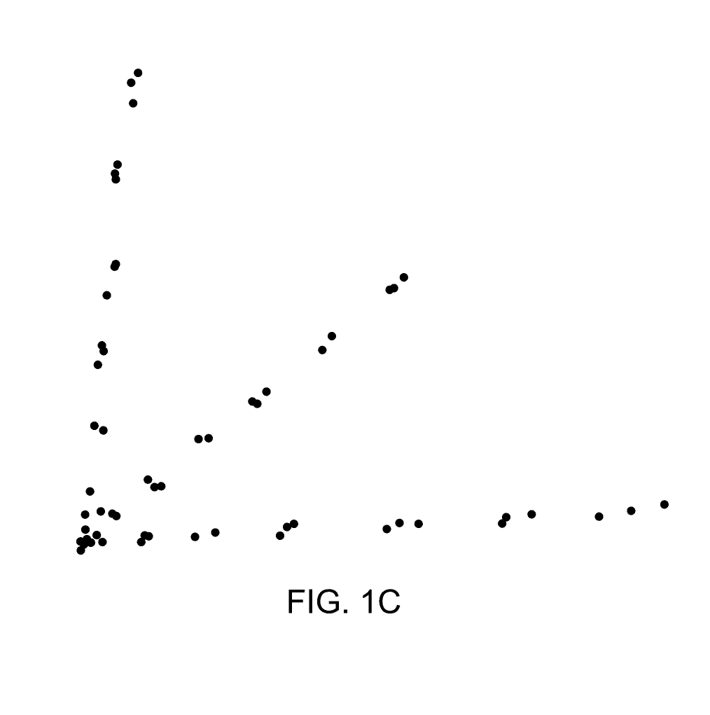

FIG. 1A is an example graph representing data that appears to be divided into three disconnected groups. In this example, the data for this graph may be associated with various physical characteristics related to different population groups or biomedical data related to different forms of a disease. Seeing that the data breaks into groups in this fashion can give insight into the data, once one understands what characterizes the groups.

FIG. 1B is an example graph representing data set obtained from a Lotka-Volterra equation modeling the populations of predators and prey over time. From FIG. 1B, one observation about this data is that it is arranged in a loop. The loop is not exactly circular, but it is topologically a circle. The exact form of the equations, while interesting, may not be of as much importance as this qualitative observation which reflects the fact that the underlying phenomenon is recurrent or periodic. When looking for periodic or recurrent phenomena, methods may be developed which can detect the presence of loops without defining explicit models. For example, periodicity may be detectable without having to first develop a fully accurate model of the dynamics.

FIG. 1C is an example graph of data sets whereby the data does not break up into disconnected groups, but instead has a structure in which there are lines (or flares) emanating from a central group. In this case, the data also suggests the presence of three distinct groups, but the connectedness of the data does not reflect this. This particular data that is the basis for the example graph in FIG. 1C arises from a study of single nucleotide polymorphisms (SNPs).

In each of the examples above, aspects of the shape of the data are relevant in reflecting information about the data. Connectedness (the simplest property of shape) reflects the presence of a discrete classification of the data into disparate groups. The presence of loops, another simple aspect of shape, often reflect periodic or recurrent behavior. Finally, in the third example, the shape containing flares suggests a classification of the data descriptive of ways in which phenomena can deviate from the norm, which would typically be represented by the central core. These examples support the idea that the shape of data (suitably defined) is an important aspect of its structure, and that it is therefore important to develop methods for analyzing and understanding its shape. The part of mathematics which concerns itself with the study of shape is called topology, and topological data analysis attempts to adapt methods for studying shape which have been developed in pure mathematics to the study of the shape of data, suitably defined.

One question is how notions of geometry or shape are translated into information about point clouds, which are, after all, finite sets? What we mean by shape or geometry can come from a dissimilarity function or metric (e.g., a non-negative, symmetric, real-valued function d on the set of pairs of points in the data set which may also satisfy the triangle inequality, and d(x; y)=0 if and only if x=y). Such functions exist in profusion for many data sets. For example, when the data comes in the form of a numerical matrix, where the rows correspond to the data points and the columns are the fields describing the data, the n-dimensional Euclidean distance function is natural when there are n fields. Similarly, in this example, there are Pearson correlation distances, cosine distances, and other choices.

When the data is not Euclidean, for example if one is considering genomic sequences, various notions of distance may be defined using measures of similarity based on Basic Local Alignment Search Tool (BLAST) type similarity scores. Further, a measure of similarity can come in non-numeric forms, such as social networks of friends or similarities of hobbies, buying patterns, tweeting, and/or professional interests. In any of these ways the notion of shape may be formulated via the establishment of a useful notion of similarity of data points.

One of the advantages of TDA is that it may depend on nothing more than such a notion, which is a very primitive or low-level model. It may rely on many fewer assumptions than standard linear or algebraic models, for example. Further, the methodology may provide new ways of visualizing and compressing data sets, which facilitate understanding and monitoring data. The methodology may enable study of interrelationships among disparate data sets and/or multiscale/multiresolution study of data sets. Moreover, the methodology may enable interactivity in the analysis of data, using point and click methods.

TDA may be a very useful complement to more traditional methods, such as Principal Component Analysis (PCA), multidimensional scaling, and hierarchical clustering. These existing methods are often quite useful, but suffer from significant limitations. PCA, for example, is an essentially linear procedure and there are therefore limits to its utility in highly non-linear situations. Multidimensional scaling is a method which is not intrinsically linear, but can in many situations wash out detail, since it may overweight large distances. In addition, when metrics do not satisfy an intrinsic flatness condition, it may have difficulty in faithfully representing the data. Hierarchical clustering does exhibit multiscale behavior, but represents data only as disjoint clusters, rather than retaining any of the geometry of the data set. In all four cases, these limitations matter for many varied kinds of data.

We now summarize example properties of an example construction, in some embodiments, which may be used for representing the shape of data sets in a useful, understandable fashion as a finite graph:
The input may be a collection of data points equipped in some way with a distance or dissimilarity function, or other description. This can be given implicitly when the data is in the form of a matrix, or explicitly as a matrix of distances or even the generating edges of a mathematical network.
One construction may also use one or more lens functions (i.e. real valued functions on the data). Lens function(s) may depend directly on the metric. For example, lens function(s) might be the result of a density estimator or a measure of centrality or data depth. Lens function(s) may, in some embodiments, depend on a particular representation of the data, as when one uses the first one or two coordinates of a principal component or multidimensional scaling analysis. In some embodiments, the lens function(s) may be columns which expert knowledge identifies as being intrinsically interesting, as in cholesterol levels and BMI in a study of heart disease.
In some embodiments, the construction may depend on a choice of two or more processing parameters, resolution, and gain. Increase in resolution typically results in more nodes and an increase in the gain increases the number of edges in a visualization and/or graph in a reference space as further described herein.
The output may be, for example, a visualization (e.g., a display of connected nodes or “network”) or simplicial complex. One specific combinatorial formulation in one embodiment may be that the vertices form a finite set, and then the additional structure may be a collection of edges (unordered pairs of vertices) which are pictured as connections in this network.

In various embodiments, a system for handling, analyzing, and visualizing data using drag and drop methods as opposed to text based methods is described herein. Philosophically, data analytic tools are not necessarily regarded as “solvers,” but rather as tools for interacting with data. For example, data analysis may consist of several iterations of a process in which computational tools point to regions of interest in a data set. The data set may then be examined by people with domain expertise concerning the data, and the data set may then be subjected to further computational analysis. In some embodiments, methods described herein provide for going back and forth between mathematical constructs, including interactive visualizations (e.g., graphs), on the one hand and data on the other.

In one example of data analysis in some embodiments described herein, an example clustering tool is discussed which may be more powerful than existing technology, in that one can find structure within clusters and study how clusters change over a period of time or over a change of scale or resolution.

An example interactive visualization tool (e.g., a visualization module which is further described herein) may produce combinatorial output in the form of a graph which can be readily visualized. In some embodiments, the example interactive visualization tool may be less sensitive to changes in notions of distance than current methods, such as multidimensional scaling.

Some embodiments described herein permit manipulation of the data from a isualization. For example, portions of the data which are deemed to be interesting from the visualization can be selected and converted into database objects, which can then be further analyzed. Some embodiments described herein permit the location of data points of interest within the visualization, so that the connection between a given visualization and the information the visualization represents may be readily understood.

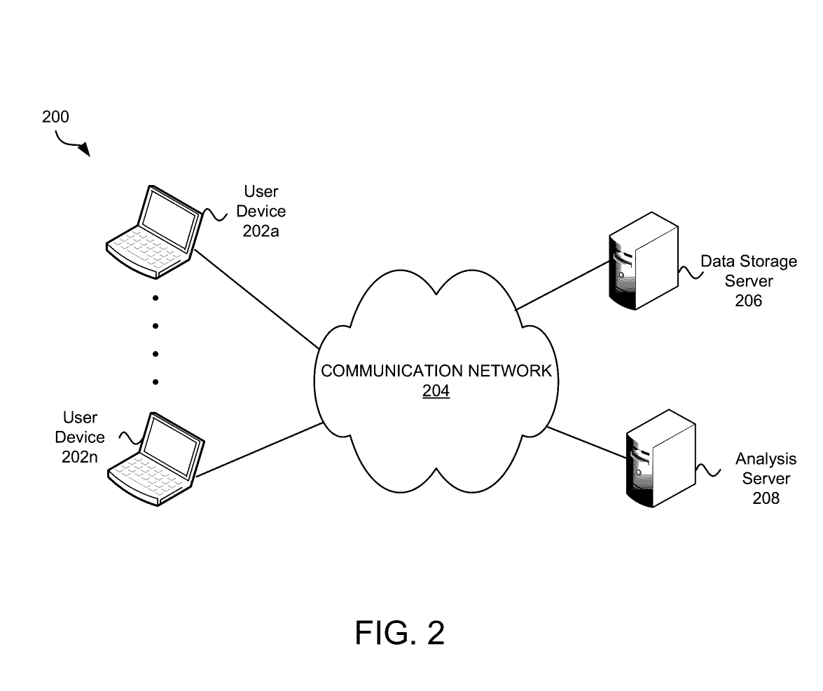

FIG. 2 is an example environment 200 in which embodiments may be practiced. In various embodiments, data analysis and interactive visualization may be performed locally (e.g., with software and/or hardware on a local digital device), across a network (e.g., via cloud computing), or a combination of both. In many of these embodiments, a data structure is accessed to obtain the data for the analysis, the analysis is performed based on properties and parameters selected by a user, and an interactive visualization is generated and displayed. There are many advantages between performing all or some activities locally and many advantages of performing all or some activities over a network.

Environment 200 comprises user devices 202a-202n, a communication network 204, data storage server 206, and analysis server 208. Environment 200 depicts an embodiment wherein functions are performed across a network. In this example, the user(s) may take advantage of cloud computing by storing data in a data storage server 206 over a communication network 204. The analysis server 208 may perform analysis and generation of an interactive visualization.

User devices 202a-202n may be any digital devices. A digital device is any device that comprises memory and a processor. Digital devices are further described in FIG. 2. The user devices 202a-202n may be any kind of digital device that may be used to access, analyze and/or view data including, but not limited to a desktop computer, laptop, notebook, or other computing device.

In various embodiments, a user, such as a data analyst, may generate a database or other data structure with the user device 202a to be saved to the data storage server 206. The user device 202a may communicate with the analysis server 208 via the communication network 204 to perform analysis, examination, and visualization of data within the database.

The user device 202a may comprise a client program for interacting with one or more applications on the analysis server 208. In other embodiments, the user device 202a may communicate with the analysis server 208 using a browser or other standard program. In various embodiments, the user device 202a communicates with the analysis server 208 via a virtual private network. It will be appreciated that that communication between the user device 202a, the data storage server 206, and/or the analysis server 208 may be encrypted or otherwise secured.

The communication network 204 may be any network that allows digital devices to communicate. The communication network 204 may be the Internet and/or include LAN and WANs. The communication network 204 may support wireless and/or wired communication.

The data storage server 206 is a digital device that is configured to store data. In various embodiments, the data storage server 206 stores databases and/or other data structures. The data storage server 206 may be a single server or a combination of servers. In one example the data storage server 206 may be a secure server wherein a user may store data over a secured connection (e.g., via https). The data may be encrypted and backed-up. In some embodiments, the data storage server 206 is operated by a third-party such as Amazon's S3 service.

The database or other data structure may comprise large high-dimensional datasets. These datasets are traditionally very difficult to analyze and, as a result, relationships within the data may not be identifiable using previous methods. Further, previous methods may be computationally inefficient.

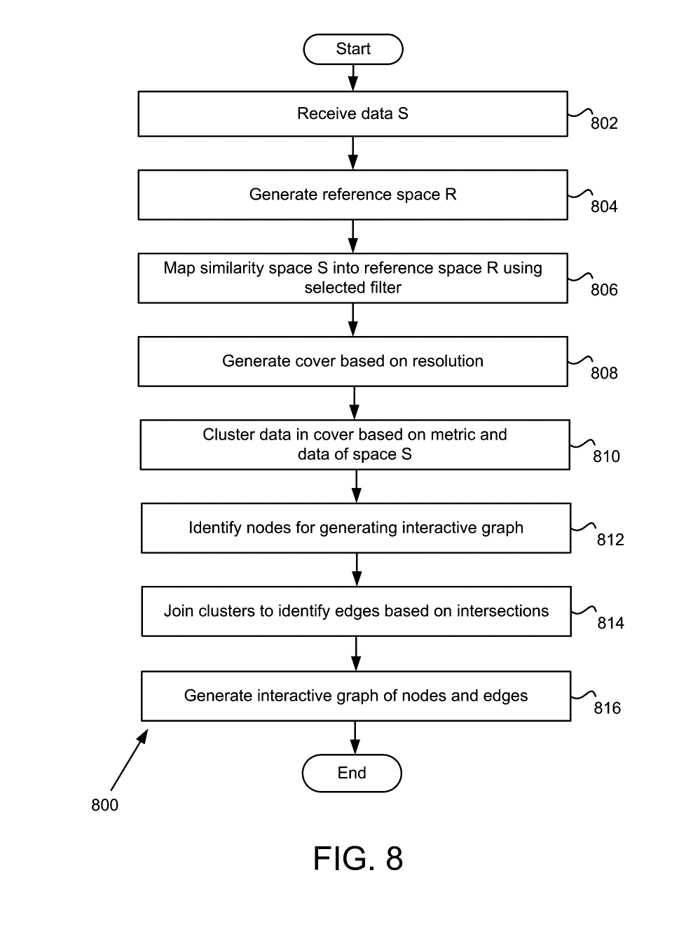

The analysis server 208 is a digital device that may be configured to analyze data. In various embodiments, the analysis server may perform many functions to interpret, examine, analyze, and display data and/or relationships within data. In some embodiments, the analysis server 208 performs, at least in part, topological analysis of large datasets applying metrics, filters, and resolution parameters chosen by the user. The analysis is further discussed in FIG. 8 herein.

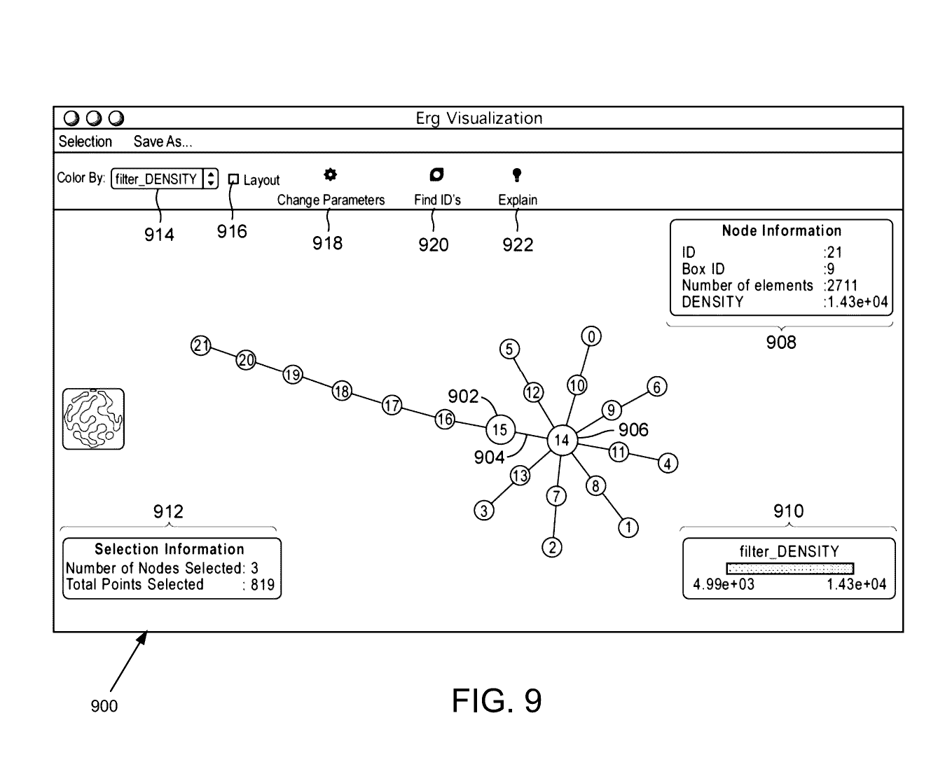

The analysis server 208 may generate an interactive visualization of the output of the analysis. The interactive visualization allows the user to observe and explore relationships in the data. In various embodiments, the interactive visualization allows the user to select nodes comprising data that has been clustered. The user may then access the underlying data, perform further analysis (e.g., statistical analysis) on the underlying data, and manually reorient the graph(s) (e.g., structures of nodes and edges described herein) within the interactive visualization. The analysis server 208 may also allow for the user to interact with the data, see the graphic result. The interactive visualization is further discussed in FIGS. 9-11.

In some embodiments, the analysis server 208 interacts with the user device(s) 202a-202n over a private and/or secure communication network. The user device 202a may comprise a client program that allows the user to interact with the data storage server 206, the analysis server 208,another user device (e.g., user device 202n) database, and/or an analysis application executed on the analysis server 208.

Those skilled in the art will appreciate that all or part of the data analysis may occur at the user device 202a. Further, all or part of the interaction with the visualization (e.g., graphic) may be performed on the user device 202a.

Although two user devices 202a and 202n are depicted, those skilled in the art will appreciate that there may be any number of user devices in any location (e.g., remote from each other). Similarly, there may be any number of communication networks, data storage servers, and analysis servers.

Cloud computing may allow for greater access to large datasets (e.g., via a commercial storage service) over a faster connection. Further, it will be appreciated that services and computing resources offered to the user(s) may be scalable.

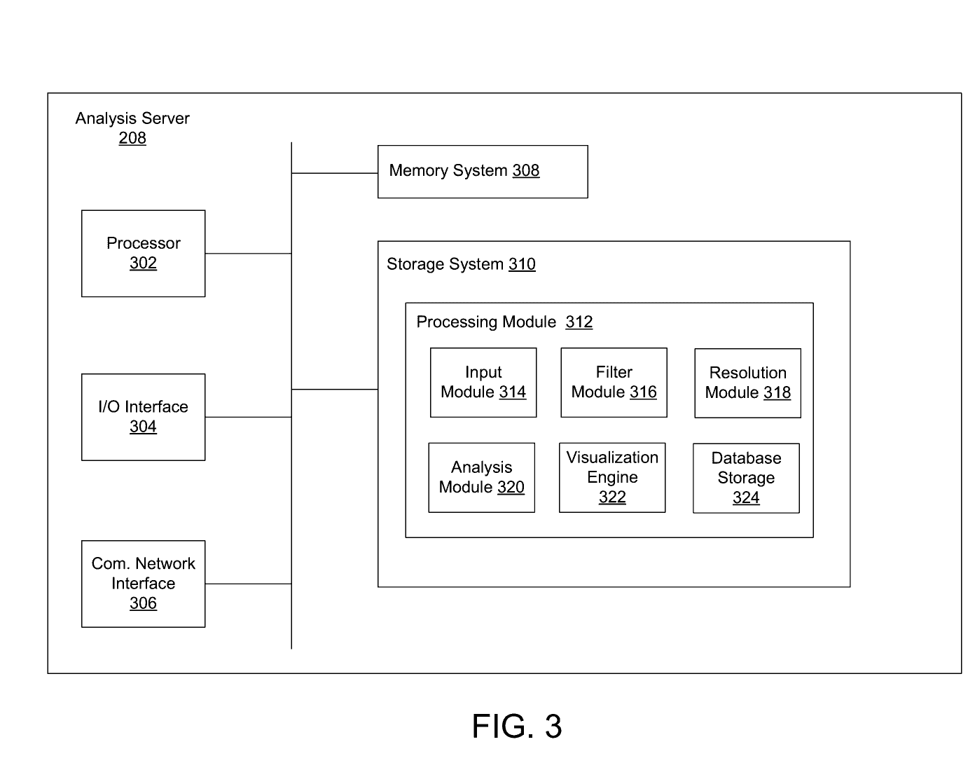

FIG. 3 is a block diagram of an example analysis server 208. In example embodiments, the analysis server 208 comprises a processor 302, input/output (I/O) interface 304, a communication network interface 306, a memory system 308, a storage system 310, and a processing module 312. The processor 302 may comprise any processor or combination of processors with one or more cores.

The input /output (I/O) interface 304 may comprise interfaces for various I/O devices such as, for example, a keyboard, mouse, and display device. The example communication network interface 306 is configured to allow the analysis server 208 to communication with the communication network 204 (see FIG. 2). The communication network interface 306 may support communication over an Ethernet connection, a serial connection, a parallel connection, and/or an ATA connection. The communication network interface 306 may also support wireless communication (e.g., 802.11 a/b/g/n, WiMax, LTE, WiFi). It will be apparent to those skilled in the art that the communication network interface 306 can support many wired and wireless standards.

The memory system 308 may be any kind of memory including RAM, ROM, or flash, cache, virtual memory, etc. In various embodiments, working data is stored within the memory system 308. The data within the memory system 308 may be cleared or ultimately transferred to the storage system 310.

The storage system 310 includes any storage configured to retrieve and store data. Some examples of the storage system 310 include flash drives, hard drives, optical drives, and/or magnetic tape. Each of the memory system 308 and the storage system 310 comprises a computer-readable medium, which stores instructions (e.g., software programs) executable by processor 302.

The storage system 310 comprises a plurality of modules utilized by embodiments of discussed herein. A module may be hardware, software (e.g., including instructions executable by a processor), or a combination of both. In one embodiment, the storage system 310 comprises a processing module 312 which comprises an input module 314, a filter module 316, a resolution module 318, an analysis module 320, a visualization engine 322, and database storage 324. Alternative embodiments of the analysis server 208 and/or the storage system 310 may comprise more, less, or functionally equivalent components and modules.

The input module 314 may be configured to receive commands and preferences from the user device 202a. In various examples, the input module 314 receives selections from the user which will be used to perform the analysis. The output of the analysis may be an interactive visualization.

The input module 314 may provide the user a variety of interface windows allowing the user to select and access a database, choose fields associated with the database, choose a metric, choose one or more filters, and identify resolution parameters for the analysis. In one example, the input module 314 receives a database identifier and accesses a large multi-dimensional database. The input module 314 may scan the database and provide the user with an interface window allowing the user to identify an ID field. An ID field is an identifier for each data point. In one example, the identifier is unique. The same column name may be present in the table from which filters are selected. After the ID field is selected, the input module 314 may then provide the user with another interface window to allow the user to choose one or more data fields from a table of the database.

Although interactive windows may be described herein, it will be appreciated that any window, graphical user interface, and/or command line may be used to receive or prompt a user or user device 202a for information.

The filter module 316 may subsequently provide the user with an interface window to allow the user to select a metric to be used in analysis of the data within the chosen data fields. The filter module 316 may also allow the user to select and/or define one or more filters.

The resolution module 218 may allow the user to select a resolution, including filter parameters. In one example, the user enters a number of intervals and a percentage overlap for a filter.

The analysis module 320 may perform data analysis based on the database and the information provided by the user. In various embodiments, the analysis module 320 performs an algebraic topological analysis to identify structures and relationships within data and clusters of data. It will be appreciated that the analysis module 320 may use parallel algorithms or use generalizations of various statistical techniques (e.g., generalizing the bootstrap to zig-zag methods) to increase the size of data sets that can be processed. The analysis is further discussed in FIG. 8. It will be appreciated that the analysis module 320 is not limited to algebraic topological analysis but may perform any analysis.

The visualization engine 322 generates an interactive visualization including the output from the analysis module 320. The interactive visualization allows the user to see all or part of the analysis graphically. The interactive visualization also allows the user to interact with the visualization. For example, the user may select portions of a graph from within the visualization to see and/or interact with the underlying data and/or underlying analysis. The user may then change the parameters of the analysis (e.g., change the metric, filter(s), or resolution(s)) which allows the user to visually identify relationships in the data that may be otherwise undetectable using prior means. The interactive visualization is further described in FIGS. 9-11.

The database storage 324 is configured to store all or part of the database that is being accessed. In some embodiments, the database storage 324 may store saved portions of the database. Further, the database storage 324 may be used to store user preferences, parameters, and analysis output thereby allowing the user to perform many different functions on the database without losing previous work.

It will be appreciated that all or part of the processing module 312 may be at the user device 202a or the database storage server 206. In some embodiments, all or some of the functionality of the processing module 312 may be performed by the user device 202a.

In various embodiments, systems and methods discussed herein may be implemented with one or more digital devices. In some examples, some embodiments discussed herein may be implemented by a computer program (instructions) executed by a processor. The computer program may provide a graphical user interface. Although such a computer program is discussed, it will be appreciated that embodiments may be performed using any of the following, either alone or in combination, including, but not limited to, a computer program, multiple computer programs, firmware, and/or hardware.

A module and/or engine may include any processor or combination of processors. In some examples, a module and/or engine may include or be a part of a processor, digital signal processor (DSP), application specific integrated circuit (ASIC), an integrated circuit, and/or the like. In various embodiments, the module and/or engine may be software or firmware.

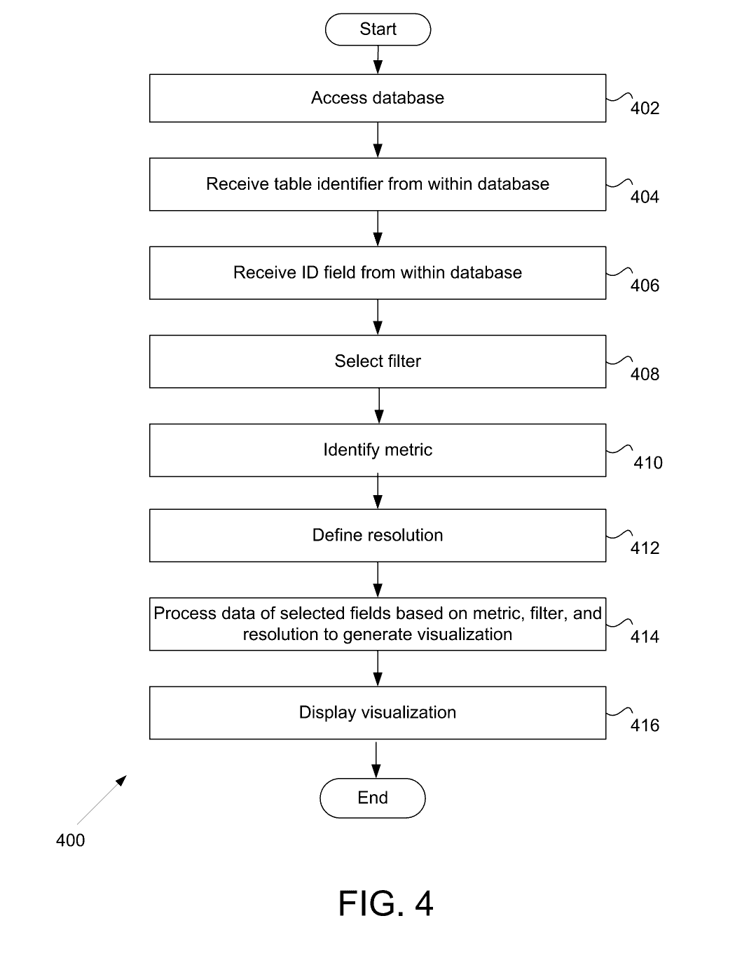

FIG. 4 is a flow chart 400 depicting an example method of dataset analysis and visualization in some embodiments. In step 402, the input module 314 accesses a database. The database may be any data structure containing data (e.g., a very large dataset of multidimensional data). In some embodiments, the database may be a relational database. In some examples, the relational database may be used with MySQL, Oracle, Micosoft SQL Server, Aster nCluster, Teradata, and/or Vertica. It will be appreciated that the database may not be a relational database.

In some embodiments, the input module 314 receives a database identifier and a location of the database (e.g., the data storage server 206) from the user device 202a (see FIG. 2). The input module 314 may then access the identified database. In various embodiments, the input module 314 may read data from many different sources, including, but not limited to MS Excel files, text files (e.g., delimited or CSV), Matlab .mat format, or any other file.

In some embodiments, the input module 314 receives an IP address or hostname of a server hosting the database, a username, password, and the database identifier. This information (herein referred to as “connection information”) may be cached for later use. It will be appreciated that the database may be locally accessed and that all, some, or none of the connection information may be required. In one example, the user device 202a may have full access to the database stored locally on the user device 202a so the IP address is unnecessary. In another example, the user device 202a may already have loaded the database and the input module 314 merely begins by accessing the loaded database.

In various embodiments, the identified database stores data within tables. A table may have a “column specification” which stores the names of the columns and their data types. A “row” in a table, may be a tuple with one entry for each column of the correct type. In one example, a table to store employee records might have a column specification such as:
employee_id primary key int (this may store the employee's ID as an integer, and uniquely identifies a row)
age int
gender char(1) (gender of the employee may be a single character either M or F)
salary double (salary of an employee may be a floating point number)
name varchar (name of the employee may be a variable-length string)
   In this example, each employee corresponds to a row in this table. Further, the tables in this example relational database are organized into logical units called databases. An analogy to file systems is that databases can be thought of as folders and files as tables. Access to databases may be controlled by the database administrator by assigning a username/password pair to authenticate users.

Once the database is accessed, the input module 314 may allow the user to access a previously stored analysis or to begin a new analysis. If the user begins a new analysis, the input module 314 may provide the user device 202a with an interface window allowing the user to identify a table from within the database. In one example, the input module 314 provides a list of available tables from the identified database.

In step 404, the input module 314 receives a table identifier identifying a table from within the database. The input module 314 may then provide the user with a list of available ID fields from the table identifier. In step 406, the input module 314 receives the ID field identifier from the user and/or user device 202a. The ID field is, in some embodiments, the primary key.

Having selected the primary key, the input module 314 may generate a new interface window to allow the user to select data fields for analysis. In step 408, the input module 314 receives data field identifiers from the user device 202a. The data within the data fields may be later analyzed by the analysis module 320.

In step 410, the filter module 316 identifies a metric. In some embodiments, the filter module 316 and/or the input module 314 generates an interface window allowing the user of the user device 202a options for a variety of different metrics and filter preferences. The interface window may be a drop down menu identifying a variety of distance metrics to be used in the analysis. Metric options may include, but are not limited to, Euclidean, DB Metric, variance normalized Euclidean, and total normalized Euclidean. The metric and the analysis are further described herein.

In step 412, the filter module 316 selects one or more filters. In some embodiments, the user selects and provides filter identifier(s) to the filter module 316. The role of the filters in the analysis is also further described herein. The filters, for example, may be user defined, geometric, or based on data which has been pre-processed. In some embodiments, the data based filters are numerical arrays which can assign a set of real numbers to each row in the table or each point in the data generally.

A variety of geometric filters may be available for the user to choose. Geometric filters may include, but are not limited to:
Density
L1 Eccentricity
L-infinity Eccentricity
Witness based Density
Witness based Eccentricity
Eccentricity as distance from a fixed point
Approximate Kurtosis of the Eccentricity

In step 414, the resolution module 218 defines the resolution to be used with a filter in the analysis. The resolution may comprise a number of intervals and an overlap parameter. In various embodiments, the resolution module 218 allows the user to adjust the number of intervals and overlap parameter (e.g., percentage overlap) for one or more filters.

In step 416, the analysis module 320 processes data of selected fields based on the metric, filter(s), and resolution(s) to generate the visualization. This process is discussed in FIG. 8.

In step 418, the visualization module 322 displays the interactive visualization. In various embodiments, the visualization may be rendered in two or three dimensional space. The visualization module 322 may use an optimization algorithm for an objective function which is correlated with good visualization (e.g., the energy of the embedding). The visualization may show a collection of nodes corresponding to each of the partial clusters in the analysis output and edges connecting them as specified by the output. The interactive visualization is further discussed in FIGS. 9-11.

Although many examples discuss the input module 314 as providing interface windows, it will be appreciated that all or some of the interface may be provided by a client on the user device 202a. Further, in some embodiments, the user device 202a may be running all or some of the processing module 212.

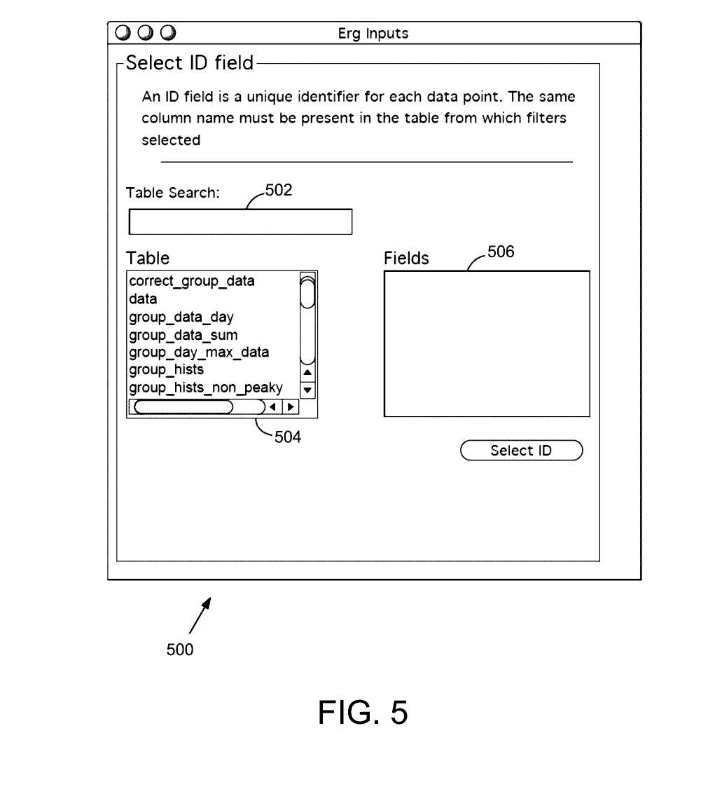

FIGS. 5-7 depict various interface windows to allow the user to make selections, enter information (e.g., fields, metrics, and filters), provide parameters (e.g., resolution), and provide data (e.g., identify the database) to be used with analysis. It will be appreciated that any graphical user interface or command line may be used to make selections, enter information, provide parameters, and provide data.

FIG. 5 is an example ID field selection interface window 500 in some embodiments. The ID field selection interface window 500 allows the user to identify an ID field. The ID field selection interface window 500 comprises a table search field 502, a table list 504, and a fields selection window 506.

In various embodiments, the input module 314 identifies and accesses a database from the database storage 324, user device 202a, or the data storage server 206. The input module 314 may then generate the ID field selection interface window 500 and provide a list of available tables of the selected database in the table list 504. The user may click on a table or search for a table by entering a search query (e.g., a keyword) in the table search field 502. Once a table is identified (e.g., clicked on by the user), the fields selection window 506 may provide a list of available fields in the selected table. The user may then choose a field from the fields selection window 506 to be the ID field. In some embodiments, any number of fields may be chosen to be the ID field(s).

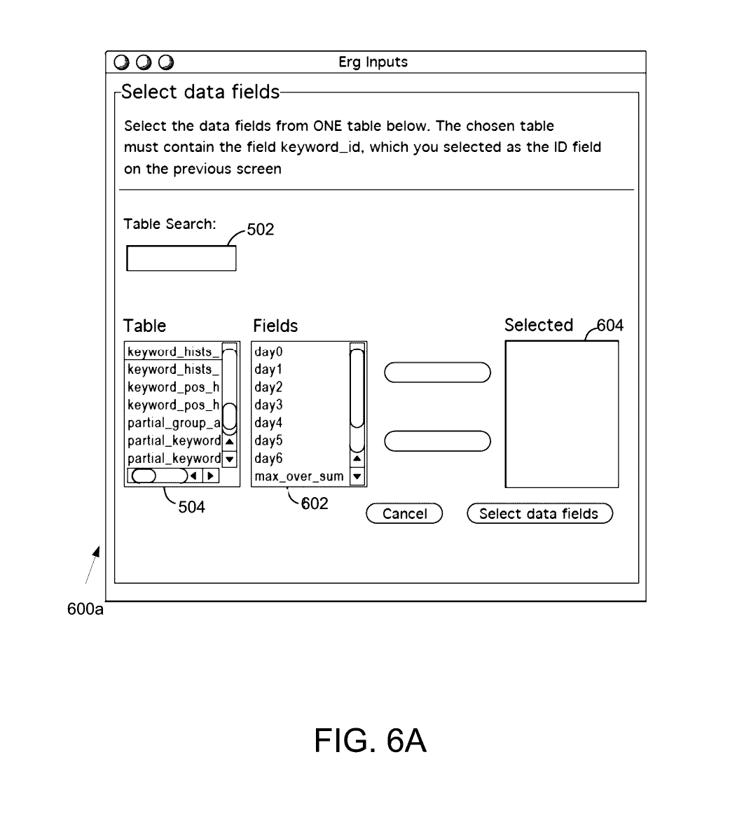

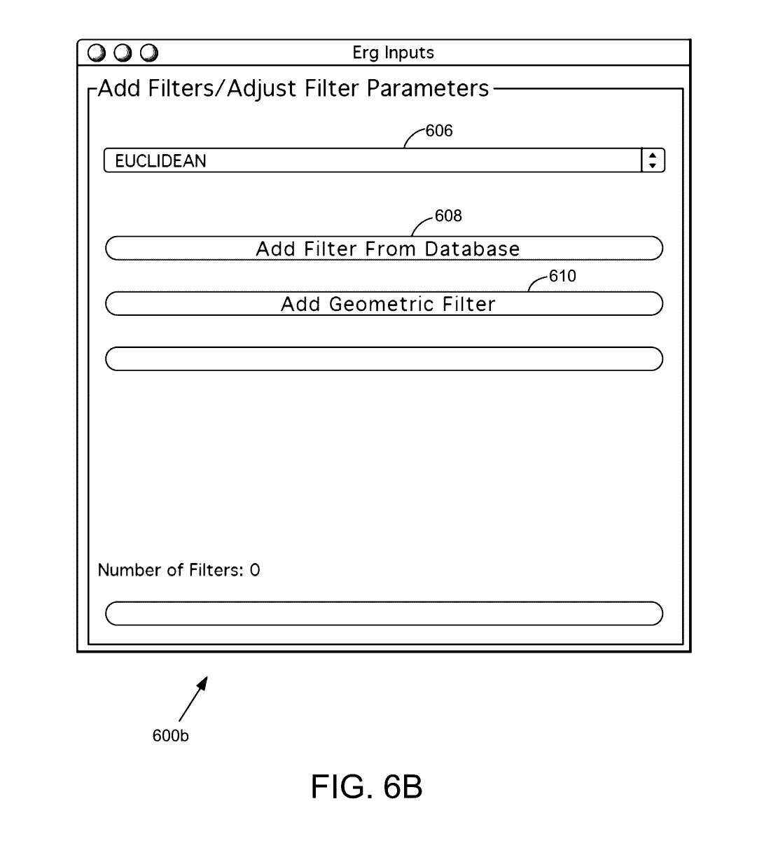

FIG. 6A is an example data field selection interface window 600a in some embodiments. The data field selection interface window 600a allows the user to identify data fields. The data field selection interface window 600a comprises a table search field 502, a table list 504, a fields selection window 602, and a selected window 604.

In various embodiments, after selection of the ID field, the input module 314 provides a list of available tables of the selected database in the table list 504. The user may click on a table or search for a table by entering a search query (e.g., a keyword) in the table search field 502. Once a table is identified (e.g., clicked on by the user), the fields selection window 506 may provide a list of available fields in the selected table. The user may then choose any number of fields from the fields selection window 602 to be data fields. The selected data fields may appear in the selected window 604. The user may also deselect fields that appear in the selected window 604.

It will be appreciated that the table selected by the user in the table list 504 may be the same table selected with regard to FIG. 5. In some embodiments, however, the user may select a different table. Further, the user may, in various embodiments, select fields from a variety of different tables.

FIG. 6B is an example metric and filter selection interface window 600b in some embodiments. The metric and filter selection interface window 600b allows the user to identify a metric, add filter(s), and adjust filter parameters. The metric and filter selection interface window 600b comprises a metric pull down menu 606, an add filter from database button 608, and an add geometric filter button 610.

In various embodiments, the user may click on the metric pull down menu 606 to view a variety of metric options. Various metric options are described herein. In some embodiments, the user may define a metric. The user defined metric may then be used with the analysis.

In one example, finite metric space data may be constructed from a data repository (i.e., database, spreadsheet, or Matlab file). This may mean selecting a collection of fields whose entries will specify the metric using the standard Euclidean metric for these fields, when they are floating point or integer variables. Other notions of distance, such as graph distance between collections of points, may be supported.

The analysis module 320 may perform analysis using the metric as a part of a distance function. The distance function can be expressed by a formula, a distance matrix, or other routine which computes it. The user may add a filter from a database by clicking on the add filter from database button 608. The metric space may arise from a relational database, a Matlab file, an Excel spreadsheet, or other methods for storing and manipulating data. The metric and filter selection interface window 600b may allow the user to browse for other filters to use in the analysis. The analysis and metric function are further described in FIG. 8.

The user may also add a geometric filter 610 by clicking on the add geometric filter button 610. In various embodiments, the metric and filter selection interface window 600b may provide a list of geometric filters from which the user may choose.

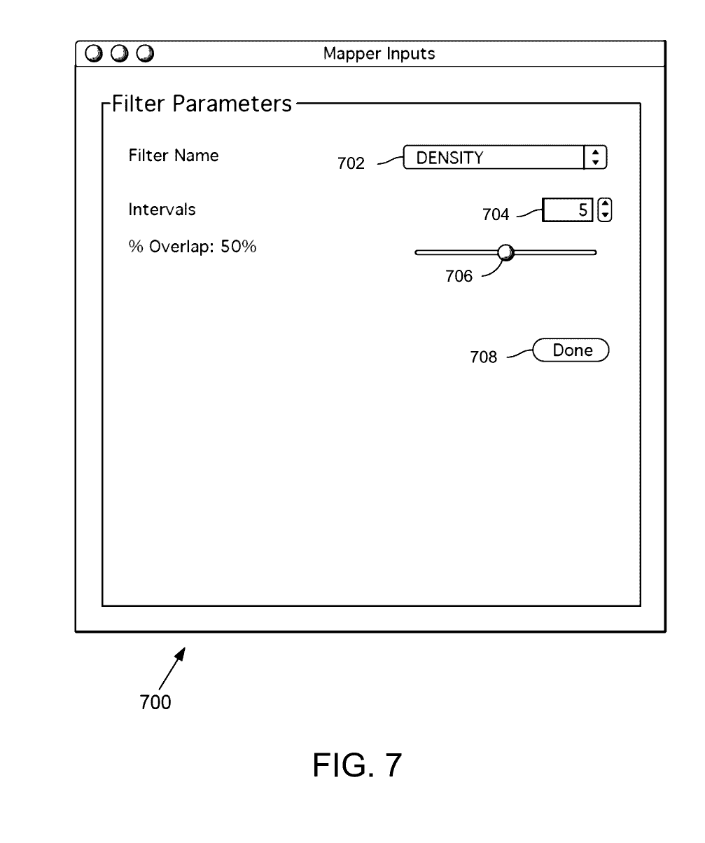

FIG. 7 is an example filter parameter interface window 700 in some embodiments. The filter parameter interface window 700 allows the user to determine a resolution for one or more selected filters (e.g., filters selected in the metric and filter selection interface window 600). The filter parameter interface window 700 comprises a filter name menu 702, an interval field 704, an overlap bar 706, and a done button 708.

The filter parameter interface window 700 allows the user to select a filter from the filter name menu 702. In some embodiments, the filter name menu 702 is a drop down box indicating all filters selected by the user in the metric and filter selection interface window 600. Once a filter is chosen, the name of the filter may appear in the filter name menu 702. The user may then change the intervals and overlap for one, some, or all selected filters.

The interval field 704 allows the user to define a number of intervals for the filter identified in the filter name menu 702. The user may enter a number of intervals or scroll up or down to get to a desired number of intervals. Any number of intervals may be selected by the user. The function of the intervals is further discussed in FIG. 8.

The overlap bar 706 allows the user to define the degree of overlap of the intervals for the filter identified in the filter name menu 702. In one example, the overlap bar 706 includes a slider that allows the user to define the percentage overlap for the interval to be used with the identified filter. Any percentage overlap may be set by the user.

Once the intervals and overlap are defined for the desired filters, the user may click the done button. The user may then go back to the metric and filter selection interface window 600 and see a new option to run the analysis. In some embodiments, the option to run the analysis may be available in the filter parameter interface window 700. Once the analysis is complete, the result may appear in an interactive visualization which is further described in FIGS. 9-11.

It will be appreciated that that interface windows in FIGS. 4-7 are example. The example interface windows are not limited to the functional objects (e.g., buttons, pull down menus, scroll fields, and search fields) shown. Any number of different functional objects may be used. Further, as described herein, any other interface, command line, or graphical user interface may be used.

FIG. 8 is a flowchart 800 for data analysis and generating an interactive visualization in some embodiments. In various embodiments, the processing on data and user-specified options is motivated by techniques from topology and, in some embodiments, algebraic topology. These techniques may be robust and general. In one example, these techniques apply to almost any kind of data for which some qualitative idea of “closeness” or “similarity” exists. The techniques discussed herein may be robust because the results may be relatively insensitive to noise in the data, user options, and even to errors in the specific details of the qualitative measure of similarity, which, in some embodiments, may be generally refer to as “the distance function” or “metric.” It will be appreciated that while the description of the algorithms below may seem general, the implementation of techniques described herein may apply to any level of generality.

In step 802, the input module 314 receives data S. In one example, a user identifies a data structure and then identifies ID and data fields. Data S may be based on the information within the ID and data fields. In various embodiments, data S is treated as being processed as a finite “similarity space,” where data S has a real-valued function d defined on pairs of points s and t in S, such that:

d(s, s)=0

d(s, t)=d(t, s)

d(s, t)>=0

These conditions may be similar to requirements for a finite metric space, but the conditions may be weaker. In various examples, the function is a metric.

It will be appreciated that data S may be a finite metric space, or a generalization thereof, such as a graph or weighted graph. In some embodiments, data S be specified by a formula, an algorithm, or by a distance matrix which specifies explicitly every pairwise distance.

In step 804, the input module 314 generates reference space R. In one example, reference space R may be a well-known metric space (e.g., such as the real line). The reference space R may be defined by the user. In step 806, the analysis module 320 generates a map ref( ) from S into R. The map ref( ) from S into R may be called the “reference map.”

In one example, a reference of map from S is to a reference metric space R. R may be Euclidean space of some dimension, but it may also be the circle, torus, a tree, or other metric space. The map can be described by one or more filters (i.e., real valued functions on S). These filters can be defined by geometric invariants, such as the output of a density estimator, a notion of data depth, or functions specified by the origin of S as arising from a data set.

In step 808, the resolution module 218 generates a cover of R based on the resolution received from the user (e.g., filter(s), intervals, and overlap—see FIG. 7). The cover of R may be a finite collection of open sets (in the metric of R) such that every point in R lies in at least one of these sets. In various examples, R is k-dimensional Euclidean space, where k is the number of filter functions. More precisely in this example, R is a box in k-dimensional Euclidean space given by the product of the intervals [min_k, max_k], where min_k is the minimum value of the k-th filter function on S, and max_k is the maximum value.

For example, suppose there are 2 filter functions, F1 and F2, and that F1's values range from −1 to +1, and F2's values range from 0 to 5. Then the reference space is the rectangle in the x/y plane with corners (−1,0), (1,0), (−1, 5), (1, 5), as every point s of S will give rise to a pair (F1(s), F2(s)) that lies within that rectangle.

In various embodiments, the cover of R is given by taking products of intervals of the covers of [min_k,max_k] for each of the k filters. In one example, if the user requests 2 intervals and a 50% overlap for F1, the cover of the interval [−1,+1] will be the two intervals (−1.5, 0.5), (−0.5, 1.5). If the user requests 5 intervals and a 30% overlap for F2, then that cover of [0, 5] will be (−0.3, 1.3), (0.7, 2.3), (1.7, 3.3), (2.7, 4.3), (3.7, 5.3). These intervals may give rise to a cover of the 2-dimensional box by taking all possible pairs of intervals where the first of the pair is chosen from the cover for F1 and the second from the cover for F2. This may give rise to 2*5, or 10, open boxes that covered the 2-dimensional reference space. However, it will be appreciated that the intervals may not be uniform, or that the covers of a k-dimensional box may not be constructed by products of intervals. In some embodiments, there are many other choices of intervals. Further, in various embodiments, a wide range of covers and/or more general reference spaces may be used.

In one example, given a cover, C1, . . . , Cm, of R, the reference map is used to assign a set of indices to each point in S, which are the indices of the Cj such that ref(s) belongs to Cj. This function may be called ref_tags(s). In a language such as Java, ref_tags would be a method that returned an int[]. Since the C's cover R in this example, ref(s) must lie in at least one of them, but the elements of the cover usually overlap one another, which means that points that “land near the edges” may well reside in multiple cover sets. In considering the two filter example, if F1(s) is −0.99, and F2(s) is 0.001, then ref(s) is (−0.99, 0.001), and this lies in the cover element (−1.5, 0.5)×(−0.3, 1.3). Supposing that was labeled C1, the reference map may assign s to the set {1}. On the other hand, if t is mapped by F1, F2 to (0.1, 2.1), then ref(t) will be in (−1.5, 0.5)×(0.7, 2.3), (−0.5, 1.5)×(0.7, 2.3), (−1.5, 0.5)×(1.7, 3.3), and (−0.5, 1.5)×(1.7, 3.3), so the set of indices would have four elements for t.

Having computed, for each point, which “cover tags” it is assigned to, for each cover element, Cd, the points may be constructed, whose tags include d, as set S(d). This may mean that every point s is in S(d) for some d, but some points may belong to more than one such set. In some embodiments, there is, however, no requirement that each S(d) is non-empty, and it is frequently the case that some of these sets are empty. In the non-parallelized version of some embodiments, each point x is processed in turn, and x is inserted into a hash-bucket for each j in ref_tags(t) (that is, this may be how S(d) sets are computed).

It will be appreciated that the cover of the reference space R may be controlled by the number of intervals and the overlap identified in the resolution (e.g., see FIG. 7). For example, the more intervals, the finer the resolution in S—that is, the fewer points in each S(d), but the more similar (with respect to the filters) these points may be. The greater the overlap, the more times that clusters in S(d) may intersect clusters in S(e)—this means that more “relationships” between points may appear, but, in some embodiments, the greater the overlap, the more likely that accidental relationships may appear.

In step 810, the analysis module 320 clusters each S(d) based on the metric, filter, and the space S. In some embodiments, a dynamic single-linkage clustering algorithm may be used to partition S(d). It will be appreciated that any number of clustering algorithms may be used with embodiments discussed herein. For example, the clustering scheme may be k-means clustering for some k, single linkage clustering, average linkage clustering, or any method specified by the user.

The significance of the user-specified inputs may now be seen. In some embodiments, a filter may amount to a “forced stretching” in a certain direction. In some embodiments, the analysis module 320 may not cluster two points unless ALL of the filter values are sufficiently “related” (recall that while normally related may mean “close,” the cover may impose a much more general relationship on the filter values, such as relating two points s and t if ref(s) and ref(t) are sufficiently close to the same circle in the plane). In various embodiments, the ability of a user to impose one or more “critical measures” makes this technique more powerful than regular clustering, and the fact that these filters can be anything, is what makes it so general.

The output may be a simplicial complex, from which one can extract its 1-skeleton. The nodes of the complex may be partial clusters, (i.e., clusters constructed from subsets of S specified as the preimages of sets in the given covering of the reference space R).

In step 812, the visualization engine 322 identifies nodes which are associated with a subset of the partition elements of all of the S(d) for generating an interactive visualization. For example, suppose that S={1, 2, 3, 4}, and the cover is C1, C2, C3. Then if ref_tags(1)={1, 2, 3} and ref_tags(2)={2, 3}, and ref_tags(3)={3}, and finally ref_tags(4)={1, 3}, then S(1) in this example is {1, 4}, S(2)={1,2}, and S(3)={1,2,3,4}. If 1 and 2 are close enough to be clustered, and 3 and 4 are, but nothing else, then the clustering for S(1) may be {1} {3}, and for S(2) it may be {1,2}, and for S(3) it may be {1,2}, {3,4}. So the generated graph has, in this example, at most four nodes, given by the sets {1},{4}, {1,2}, and {3,4} (note that {1,2} appears in two different clusterings). Of the sets of points that are used, two nodes intersect provided that the associated node sets have a non-empty intersection (although this could easily be modified to allow users to require that the intersection is “large enough” either in absolute or relative terms).

Nodes may be eliminated for any number of reasons. For example, a node may be eliminated as having too few points and/or not being connected to anything else. In some embodiments, the criteria for the elimination of nodes (if any) may be under user control or have application-specific requirements imposed on it. For example, if the points are consumers, for instance, clusters with too few people in area codes served by a company could be eliminated. If a cluster was found with “enough” customers, however, this might indicate that expansion into area codes of the other consumers in the cluster could be warranted.

In various embodiments, an open cover of the space of the intermarket and/or macro-economic data may be utilized to group or potentially group data points of the originally received data. It will be appreciated that there may be any number of covers on the space of the originally received data without using any reference space. The cover(s) may group data points or identify related data points for further assessment whether to include as members of the same node. In some embodiments, covers may be used in both the reference space and the data space of the originally received data. The covers may be utilized to assist in grouping data points as members of any number of nodes.

In step 814, the visualization engine 322 joins clusters to identify edges (e.g., connecting lines between nodes). Once the nodes are constructed, the intersections (e.g., edges) may be computed “all at once,” by computing, for each point, the set of node sets (not ref_tags, this time). That is, for each s in S, node_id_set(s) may be computed, which is an int[]. In some embodiments, if the cover is well behaved, then this operation is linear in the size of the set S, and we then iterate over each pair in node_id_set(s). There may be an edge between two node_id's if they both belong to the same node_id_set( )value, and the number of points in the intersection is precisely the number of different node id sets in which that pair is seen. This means that, except for the clustering step (which is often quadratic in the size of the sets S(d), but whose size may be controlled by the choice of cover), all of the other steps in the graph construction algorithm may be linear in the size of S, and may be computed quite efficiently.

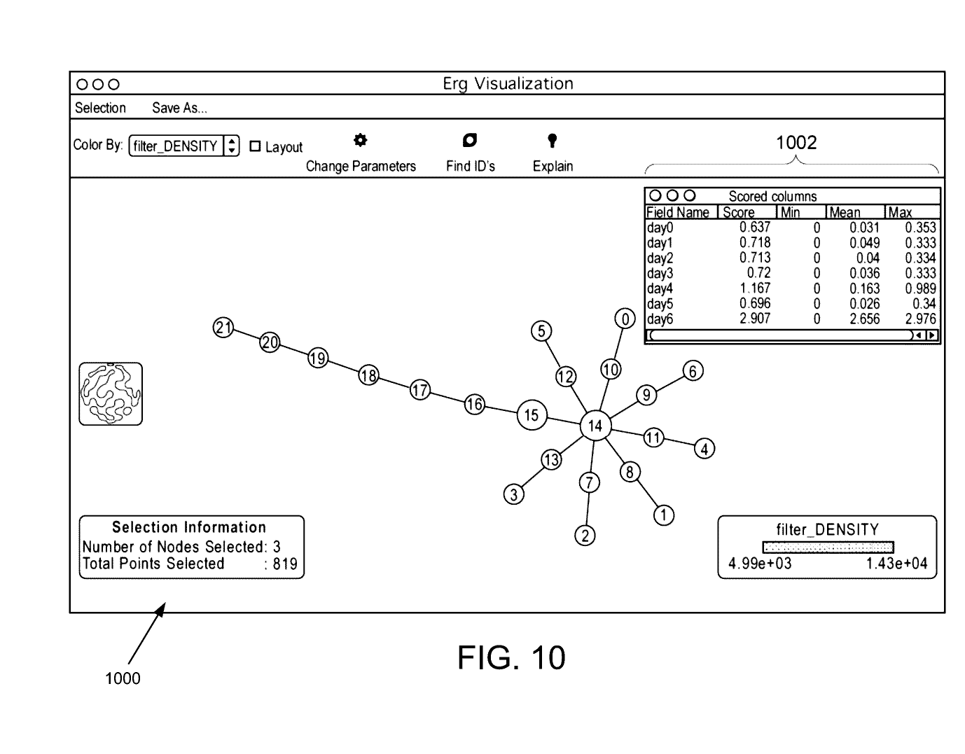

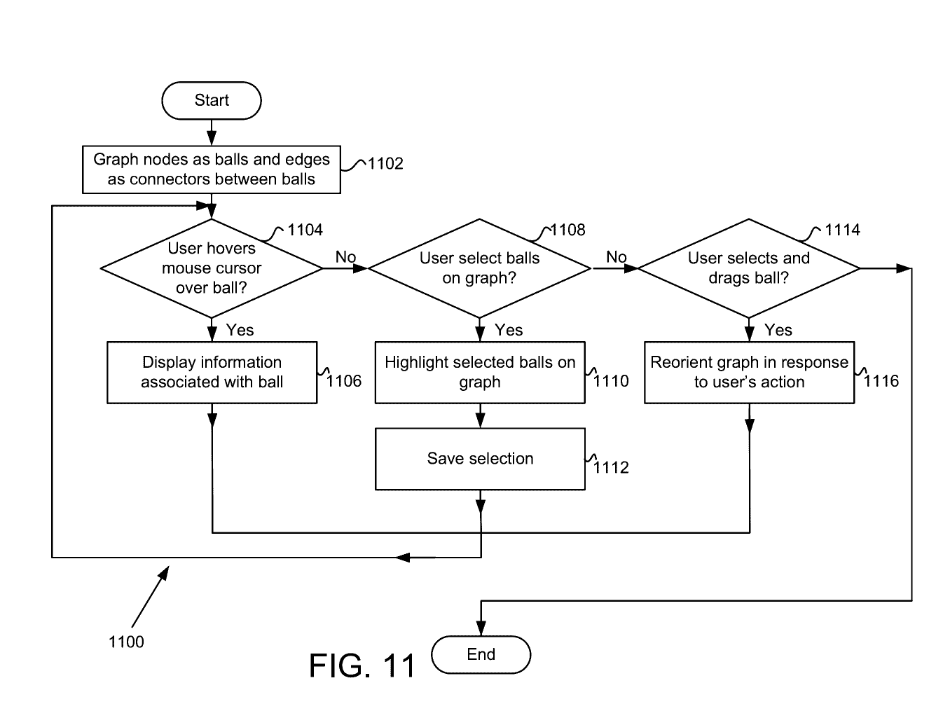

In step 816, the visualization engine 322 generates the interactive visualization of interconnected nodes (e.g., nodes and edges displayed in FIGS. 10 and 11).

It will be appreciated that it is possible, in some embodiments, to make sense in a fairly deep way of connections between various ref( ) maps and/or choices of clustering. Further, in addition to computing edges (pairs of nodes), the embodiments described herein may be extended to compute triples of nodes, etc. For example, the analysis module 320 may compute simplicial complexes of any dimension (by a variety of rules) on nodes, and apply techniques from homology theory to the graphs to help users understand a structure in an automatic (or semi-automatic) way.

Further, it will be appreciated that uniform intervals in the covering may not always be a good choice. For example, if the points are exponentially distributed with respect to a given filter, uniform intervals can fail—in such case adaptive interval sizing may yield uniformly-sized S(d) sets, for instance.

Further, in various embodiments, an interface may be used to encode techniques for incorporating third-party extensions to data access and display techniques. Further, an interface may be used to for third-party extensions to underlying infrastructure to allow for new methods for generating coverings, and defining new reference spaces.

FIG. 9 is an example interactive visualization 900 in some embodiments. The display of the interactive visualization may be considered a “graph” in the mathematical sense. The interactive visualization comprises of two types of objects: nodes (e.g., nodes 902 and 906) (the colored balls) and the edges (e.g., edge 904) (the black lines). The edges connect pairs of nodes (e.g., edge 904 connects node 902 with node 906). As discussed herein, each node may represent a collection of data points (rows in the database identified by the user). In one example, connected nodes tend to include data points which are “similar to” (e.g., clustered with) each other. The collection of data points may be referred to as being “in the node.” The interactive visualization may be two-dimensional, three-dimensional, or a combination of both.

In various embodiments, connected nodes and edges may form a graph or structure. There may be multiple graphs in the interactive visualization. In one example, the interactive visualization may display two or more unconnected structures of nodes and edges.

The visual properties of the nodes and edges (such as, but not limited to, color, stroke color, text, texture, shape, coordinates of the nodes on the screen) can encode any data based property of the data points within each node. For example, coloring of the nodes and/or the edges may indicate (but is not limited to) the following:
Values of fields or filters
Any general functions of the data in the nodes (e.g., if the data were unemployment rates by state, then GDP of the states may be identifiable by color the nodes)
Number of data points in the node

The interactive visualization 900 may contain a “color bar” 910 which may comprise a legend indicating the coloring of the nodes (e.g., balls) and may also identify what the colors indicate. For example, in FIG. 9, color bar 910 indicates that color is based on the density filter with blue (on the far left of the color bar 910) indicating “4.99e+03” and red (on the far right of the color bar 910) indicating “1.43e+04.” In general this might be expanded to show any other legend by which nodes and/or edges are colored. It will be appreciated that the, In some embodiments, the user may control the color as well as what the color (and/or stroke color, text, texture, shape, coordinates of the nodes on the screen) indicates.

The user may also drag and drop objects of the interactive visualization 900. In various embodiments, the user may reorient structures of nodes and edges by dragging one or more nodes to another portion of the interactive visualization (e.g., a window). In one example, the user may select node 902, hold node 902, and drag the node across the window. The node 902 will follow the user's cursor, dragging the structure of edges and/or nodes either directly or indirectly connected to the node 902. In some embodiments, the interactive visualization 900 may depict multiple unconnected structures. Each structure may include nodes, however, none of the nodes of either structure are connected to each other. If the user selects and drags a node of the first structure, only the first structure will be reoriented with respect to the user action. The other structure will remain unchanged. The user may wish to reorient the structure in order to view nodes, select nodes, and/or better understand the relationships of the underlying data.

In one example, a user may drag a node to reorient the interactive visualization (e.g., reorient the structure of nodes and edges). While the user selects and/or drags the node, the nodes of the structure associated with the selected node may move apart from each other in order to provide greater visibility. Once the user lets go (e.g., deselects or drops the node that was dragged), the nodes of the structure may continue to move apart from each other.

In various embodiments, once the visualization module 322 generates the interactive display, the depicted structures may move by spreading out the nodes from each other. In one example, the nodes spread from each other slowly allowing the user to view nodes distinguish from each other as well as the edges. In some embodiments, the visualization module 322 optimizes the spread of the nodes for the user's view. In one example, the structure(s) stop moving once an optimal view has been reached.

It will be appreciated that the interactive visualization 900 may respond to gestures (e.g., multitouch), stylus, or other interactions allowing the user to reorient nodes and edges and/or interacting with the underlying data.

The interactive visualization 900 may also respond to user actions such as when the user drags, clicks, or hovers a mouse cursor over a node. In some embodiments, when the user selects a node or edge, node information or edge information may be displayed. In one example, when a node is selected (e.g., clicked on by a user with a mouse or a mouse cursor hovers over the node), a node information box 908 may appear that indicates information regarding the selected node. In this example, the node information box 908 indicates an ID, box ID, number of elements (e.g., data points associated with the node), and density of the data associated with the node.

The user may also select multiple nodes and/or edges by clicking separate on each object, or drawing a shape (such as a box) around the desired objects. Once the objects are selected, a selection information box 912 may display some information regarding the selection. For example, selection information box 912 indicates the number of nodes selected and the total points (e.g., data points or elements) of the selected nodes.

The interactive visualization 900 may also allow a user to further interact with the display. Color option 914 allows the user to display different information based on color of the objects. Color option 914 in FIG. 9 is set to filter_Density, however, other filters may be chosen and the objects re-colored based on the selection. It will be appreciated that the objects may be colored based on any filter, property of data, or characterization. When a new option is chosen in the color option 914, the information and/or colors depicted in the color bar 910 may be updated to reflect the change.

Layout checkbox 914 may allow the user to anchor the interactive visualization 900. In one example, the layout checkbox 914 is checked indicating that the interactive visualization 900 is anchored. As a result, the user will not be able to select and drag the node and/or related structure. Although other functions may still be available, the layout checkbox 914 may help the user keep from accidentally moving and/or reorienting nodes, edges, and/or related structures. It will be appreciated that the layout checkbox 914 may indicate that the interactive visualization 900 is anchored when the layout checkbox 914 is unchecked and that when the layout checkbox 914 is checked the interactive visualization 900 is no longer anchored.

The change parameters button 918 may allow a user to change the parameters (e.g., add/remove filters and/or change the resolution of one or more filters). In one example, when the change parameters button 918 is activated, the user may be directed back to the metric and filter selection interface window 600 (see FIG. 6) which allows the user to add or remove filters (or change the metric). The user may then view the filter parameter interface 700 (see FIG. 7) and change parameters (e.g., intervals and overlap) for one or more filters. The analysis module 320 may then re-analyze the data based on the changes and display a new interactive visualization 900 without again having to specify the data sets, filters, etc.

The find ID's button 920 may allow a user to search for data within the interactive visualization 900. In one example, the user may click the find ID's button 920 and receive a window allowing the user to identify data or identify a range of data. Data may be identified by ID or searching for the data based on properties of data and/or metadata. If data is found and selected, the interactive visualization 900 may highlight the nodes associated with the selected data. For example, selecting a single row or collection of rows of a database or spreadsheet may produce a highlighting of nodes whose corresponding partial cluster contains any element of that selection.

In various embodiments, the user may select one or more objects and click on the explain button 922 to receive in-depth information regarding the selection. In some embodiments, when the user selects the explain button 922, the information about the data from which the selection is based may be displayed. The function of the explain button 922 is further discussed with regard to FIG. 10.

In various embodiments, the interactive visualization 900 may allow the user to specify and identify subsets of interest, such as output filtering, to remove clusters or connections which are too small or otherwise uninteresting. Further, the interactive visualization 900 may provide more general coloring and display techniques, including, for example, allowing a user to highlight nodes based on a user-specified predicate, and coloring the nodes based on the intensity of user-specified weighting functions.

The interactive visualization 900 may comprise any number of menu items. The “Selection” menu may allow the following functions:
Select singletons (select nodes which are not connected to other nodes)
Select all (selects all the nodes and edges)
Select all nodes (selects all nodes)
Select all edges
Clear selection (no selection)
Invert Selection (selects the complementary set of nodes or edges)
Select “small” nodes (allows the user to threshold nodes based on how many points they have)
Select leaves (selects all nodes which are connected to long “chains” in the graph)
Remove selected nodes
Show in a table (shows the selected nodes and their associated data in a table)
Save selected nodes (saves the selected data to whatever format the user chooses. This may allow the user to subset the data and create new datasources which may be used for further analysis.)

In one example of the “show in a table” option, information from a selection of nodes may be displayed. The information may be specific to the origin of the data. In various embodiments, elements of a database table may be listed, however, other methods specified by the user may also be included. For example, in the case of microarray data from gene expression data, heat maps may be used to view the results of the selections.

The interactive visualization 900 may comprise any number of menu items. The “Save” menu may allow may allow the user to save the whole output in a variety of different formats such as (but not limited to):
Image files (PNG/JPG/PDF/SVG etc.)
Binary output (The interactive output is saved in the binary format. The user may reopen this file at any time to get this interactive window again)
   In some embodiments, graphs may be saved in a format such that the graphs may be used for presentations. This may include simply saving the image as a pdf or png file, but it may also mean saving an executable .xml file, which may permit other users to use the search and save capability to the database on the file without having to recreate the analysis.

In various embodiments, a relationship between a first and a second analysis output/interactive visualization for differing values of the interval length and overlap percentage may be displayed. The formal relationship between the first and second analysis output/interactive visualization may be that when one cover refines the next, there is a map of simplicial complexes from the output of the first to the output of the second. This can be displayed by applying a restricted form of a three-dimensional graph embedding algorithm, in which a graph is the union of the graphs for the various parameter values and in which the connections are the connections in the individual graphs as well as connections from one node to its image in the following graph. The constituent graphs may be placed in its own plane in 3D space. In some embodiments, there is a restriction that each constituent graph remain within its associated plane. Each constituent graph may be displayed individually, but a small change of parameter value may result in the visualization of the adjacent constituent graph. In some embodiments, nodes in the initial graph will move to nodes in the next graph, in a readily visualizable way.

FIG. 10 is an example interactive visualization 1000 displaying an explain information window 1002 in some embodiments. In various embodiments, the user may select a plurality of nodes and click on the explain button. When the explain button is clicked, the explain information window 1002 may be generated. The explain information window 1002 may identify the data associated with the selected object(s) as well as information (e.g., statistical information) associated with the data.

In some embodiments, the explain button allows the user to get a sense for which fields within the selected data fields are responsible for “similarity” of data in the selected nodes and the differentiating characteristics. There can be many ways of scoring the data fields. The explain information window 1002 (i.e., the scoring window in FIG. 10) is shown along with the selected nodes. The highest scoring fields may distinguish variables with respect to the rest of the data.

In one example, the explain information window 1002 indicates that data from fields day0-day6 has been selected. The minimum value of the data in all of the fields is 0. The explain information window 1002 also indicates the maximum values. For example, the maximum value of all of the data associated with the day0 field across all of the points of the selected nodes is 0.353. The average (i.e., mean) of all of the data associated with the day0 field across all of the points of the selected nodes is 0.031. The score may be a relative (e.g., normalized) value indicating the relative function of the filter; here, the score may indicate the relative density of the data associated with the day0 field across all of the points of the selected nodes. It will be appreciated that any information regarding the data and/or selected nodes may appear in the explain information window 1002.

It will be appreciated that the data and the interactive visualization 1000 may be interacted with in any number of ways. The user may interact with the data directly to see where the graph corresponds to the data, make changes to the analysis and view the changes in the graph, modify the graph and view changes to the data, or perform any kind of interaction.

FIG. 11 is a flowchart 1200 of functionality of the interactive visualization in some embodiments. In step 1202, the visualization engine 322 receives the analysis from the analysis module 320 and graphs nodes as balls and edges as connectors between balls 1202 to create interactive visualization 900 (see FIG. 9).

In step 1204, the visualization engine 322 determines if the user is hovering a mouse cursor (or has selected) a ball (i.e., a node). If the user is hovering a mouse cursor over a ball or selecting a ball, then information is displayed regarding the data associated with the ball. In one example, the visualization engine 322 displays a node information window 908.

If the visualization engine 322 does not determine that the user is hovering a mouse cursor (or has selected) a ball, then the visualization engine 322 determines if the user has selected balls on the graph (e.g., by clicking on a plurality of balls or drawing a box around a plurality of balls). If the user has selected balls on the graph, the visualization engine 322 may highlight the selected balls on the graph in step 1110. The visualization engine 322 may also display information regarding the selection (e.g., by displaying a selection information window 912). The user may also click on the explain button 922 to receive more information associated with the selection (e.g., the visualization engine 322 may display the explain information window 1002).

In step 1112, the user may save the selection. For example, the visualization engine 322 may save the underlying data, selected metric, filters, and/or resolution. The user may then access the saved information and create a new structure in another interactive visualization 900 thereby allowing the user to focus attention on a subset of the data.

If the visualization engine 322 does not determine that the user has selected balls on the graph, the visualization engine 322 may determine if the user selects and drags a ball on the graph in step 1114. If the user selects and drags a ball on the graph, the visualization engine 322 may reorient the selected balls and any connected edges and balls based on the user's action in step 1116. The user may reorient all or part of the structure at any level of granularity.

It will be appreciated that although FIG. 11 discussed the user hovering over, selecting, and/or dragging a ball, the user may interact with any object in the interactive visualization 900 (e.g., the user may hover over, select, and/or drag an edge). The user may also zoom in or zoom out using the interactive visualization 900 to focus on all or a part of the structure (e.g., one or more balls and/or edges).

Further, although balls are discussed and depicted in FIGS. 9-11, it will be appreciated that the nodes may be any shape and appear as any kind of object. Further, although some embodiments described herein discuss an interactive visualization being generated based on the output of algebraic topology, the interactive visualization may be generated based on any kind of analysis and is not limited.

Financial markets continuously produce large quantities of multi-dimensional data for a variety of assets and financial instruments. Assets and financial instruments may include for example, equities, commodities, futures, options, swaps, bonds, and currencies. Examples of data may include, but are not limited to, asset prices, trade volumes, volatility surfaces, interest rates, trade counterparty information, order book information from stock exchanges and other market liquidity providers, accounting data (such as income statements and balance sheets), and/or regulatory filings. The analyses of these datasets may be jointly performed along with economic data. Example economic data may include, but is not limited to, unemployment rates, jobless claims data, GDP growth rates, ISM manufacturing index data, and inflation data. The data may include global macro and market-related factors and transforms.

Datasets may be jointly analyzed in order to produce forecast estimates of financial market information. Example financial market information may include, but is not limited to, asset returns, volatility, liquidity, and/or cross-asset correlations. These forecast estimates may be used with human or computer-aided decision support systems to design trades, allocate capital across multiple assets, identify over-bought and over-sold assets, identify potential areas of incipient market risk, and/or create volume profiles for algorithmic execution of trades.

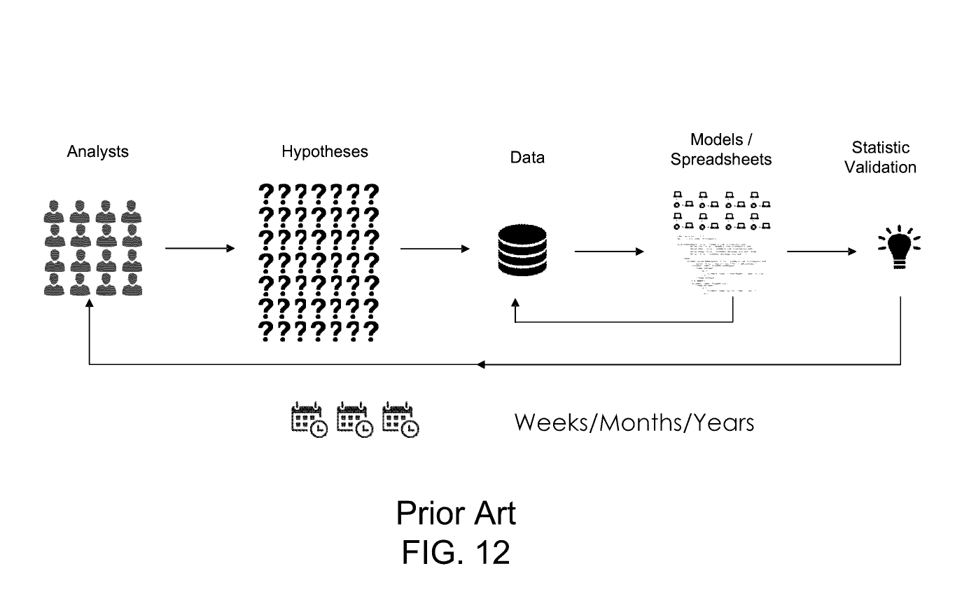

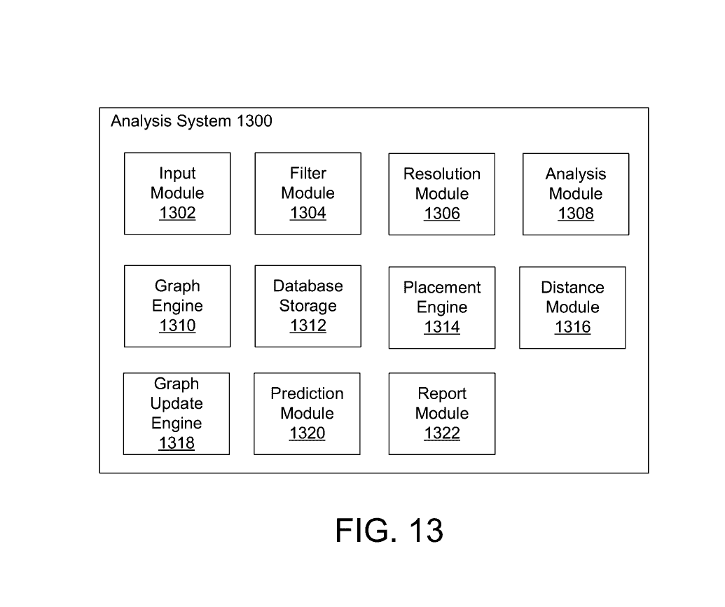

FIG. 12 depicts a general process of forming a hypothesis and testing the hypothesis in the prior art. Conventional methods of analyzing financial information typically involve a set of well-trained analysis who propose a hypothesis regarding something in a financial portfolio and a relationship to other predictive characteristics. The hypothesis is typically based on market theory, guesses on past history, and assumed relationships. The hypothesis is subsequently encoded in a model or spreadsheet.

Once a model is generated, the model is evaluated to determine if the model is statistically valid (e.g., using past history information to see if the model performs with desired results). If the model is not statistically valid or not sufficiently statistically valid, then the model may be changed and retested. Alternately, the analysists may propose a new hypothesis that may or may not be based on the previous model testing. The new hypothesis is again encoded and the model tested to determine if statistically valid. The process will repeat until a correct hypothesis is formed or too much time has elapsed (desired financial predictions tend to be time sensitive).

There are many problems with this process. One problem is complexity. There may be many aspects of a complex market and economic system that impact a prediction. The hypothesis and ultimate prediction must take into account and weigh influencing many influencing factors for the prediction to be reliable. For example, a prediction based on only major influencing economic factors may lead to a correct prediction for an asset's behavior once but fail in the future even if the major influencing economic factors are the same. This is because many other factors in the aggregate may impact asset behavior and these other factors may render the prediction invalid.

Another problem with the prior art is that the process is confirmatory; success is only achieved by making a correct hypothesis prior to testing of the hypothesis. As a result, it cannot be determined when a successful hypothesis will be posed. A related problem is that predictions are time sensitive (e.g., the reason for going through the process is to make a prediction of an asset in a timely matter in order to generate profit or avoid loss). Since the prior art process requires correctly guessing a valid hypothesis, the amount of time required to find a statistically valid model based on the hypothesis is unpredictable and opportunity can be lost.

Hypotheses are often created by looking at how different business cycles unfold and assessing fundamental account information to project how an asset or equity sector will perform. Quantitative and technical analysis of asset information may take into account price charts to identify patterns and make projections into the future. This is a bottom up approach and does not take into account broader market conditions or intermarket analysis that would impact individual assets or equity sectors.

Further, analysis of these datasets in the prior art has include clustering, linear regression, principal component analysis, multi-dimensional scaling, and/or projection pursuit. Unfortunately, application of these methods to these large multi-dimensional dataset tends to produce insufficient performance and may be computationally inefficient. These methods may also fail to capture relationships across dimensions of data due to their focus on reducing the number of dimensions in order to make the resultant computations more tractable.

Classical finance theory assumes that asset returns are independent and identically distributed. However, analysis of financial market and economic data indicates that the distribution of asset returns may be dependent upon the regime exhibited by financial markets at the time of measurement and forecasting (i.e., the market regime).

A market regime may be viewed as a tuple (i.e., a sequence of “n” elements where “n” is a non-negative integer) of features derived from financial market and economic data that encapsulates financial market behavior. A tuple is a sequence of “n” elements where “n.” There may be many kinds of financial market behavior that include, but is not limited to, recent asset returns, recent realized asset volatilities, changes in asset volatilities, changes in interest rate levels, changes in unemployment rate levels, changes in GDP growth rate levels, and/or changes in macroeconomic indicators such as the ECRI Leading Index. Market regimes may indicate desirable statistical properties. For example, market regimes may be stable for a short or intermediate term (e.g., for a short or intermediate period of time). Conditioning the forecasting distribution of market information on the current market regime may lead to more demonstrably accurate forecasts.

Topological Data Analysis (TDA) market regime detection is a framework that may be used to perform accurate estimates of financial market information. TDA market regime detection may operate as part of a manual or automated process comprising of a system and workflow iterating over subsets of financial market and economic data identified using TDA.

As discussed herein, an analysis server (e.g., as discussed regarding FIG. 3) or an analysis system (see FIG. 13) may perform TDA on financial and/or market data received from any number of sources. The financial and/or market data may include intermarket and/or macro-economic data. The analysis server or analysis system may utilize any number of lenses and metrics to identify and/or depict the shape of data representative of relationships without the requirement of forming an initial hypothesis. Subsequently, new information may be placed relative to the shape of the previous data to determine relationships of intermarket and/or macro-economic data that may influence financial behavior or financial vehicles and strategies related to the new information. This process may be utilized to forecast an asset, financial market information, changes in business cycles, and/or interday trading volume.

All four of these processes may include the analysis server or analysis system utilizing similar or different intermarket and/or macro-economic data to generate a TDA graph or graph. It will be appreciated that the graph may or may not be visualized (e.g., the graph may or may not be a visualization).

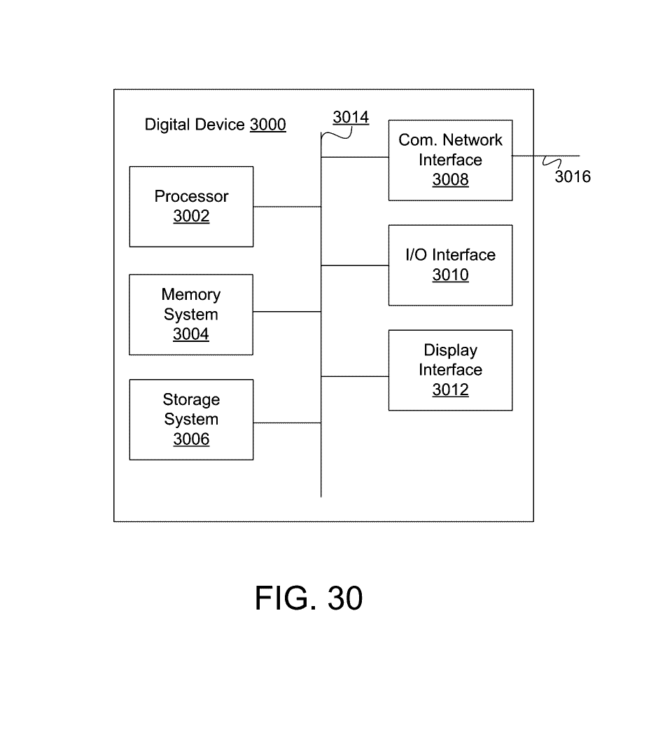

FIG. 13 depicts an example analysis system 1300 in some embodiments. The analysis system 1300 may be a part of the analysis server 208. In some embodiments, the analysis system 1300 includes similar modules as that discussed regarding FIG. 3. The analysis system 1300 may be operated on a digital device as discussed regarding FIG. 30. In some embodiments, the analysis system 1300 may comprise a storage system that includes the modules, storage, and/or engines discussed with regard to FIG. 13.

Similar to the analysis server 208 discussed herein, the analysis system 1300 may include an input module 1302, a filter module 1304, a resolution module 1306, an analysis module 1308, a graph engine 1310, and a database storage 1312. The input module 1302, filter module 1304, resolution module 1306, analysis module 1308, and graph engine 1310 may be utilized, in some embodiments, to perform TDA on financial data (e.g., intermarket and/or macro-economic data). The analysis system 1300 may further include a placement engine 1314, a distance module 1316, a graph update engine 1318, a prediction module 1320, and a report module 1322.

A module, like an engine, may be hardware, software (e.g., including instructions executable by a processor), or a combination of both. Alternative embodiments of the analysis system 1300 may comprise more, less, or functionally equivalent components and modules.

The input module 1302 may be configured to receive commands and preferences from a user device (e.g., user device 202a). In various examples, the input module 1302 receives selections from the user which will be used to perform the analysis. The output of the analysis may be an interactive visualization from the graph engine 1310 or a report from the report module 1322 (e.g., a graphic, table, text, or any combination).

In some embodiments, the input module 1302 may provide the user a variety of interface windows allowing the user to select and access a database, choose fields associated with the database, choose a metric, choose one or more filters, and identify resolution parameters for the analysis. In one example, the input module 1302 receives a database identifier and accesses a large multi-dimensional database. The input module 1302 may scan the database and provide the user with an interface window allowing the user to identify an ID field. An ID field is an identifier for each data point. In one example, the identifier is unique. The ID field can include any identifier. In one example, the ID field includes dates or labels indicating a time, date, period of time, or the like. The same column name may be present in the table from which filters are selected. After the ID field is selected, the input module 1302 may then provide the user with another interface window to allow the user to choose one or more data fields from a table of the database.

Although interactive windows may be described herein, it will be appreciated that any window, graphical user interface, and/or command line may be used to receive or prompt a user or user device 202a for information.

The filter module 1304 may subsequently provide the user with an interface window to allow the user to select a metric to be used in analysis of the data within the chosen data fields. The filter module 316 may also allow the user to select and/or define one or more filters.

The resolution module 1306 may allow the user to select a resolution and gain, including filter parameters. In one example, the user enters a number of intervals and a percentage overlap for a filter.

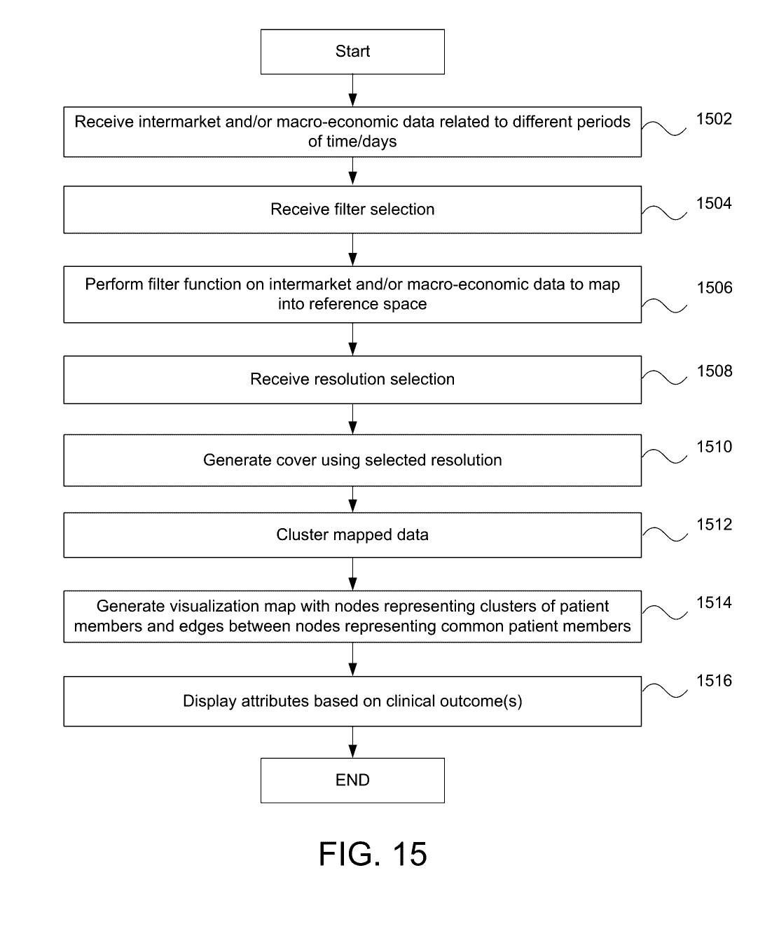

The analysis module 1308 may perform data analysis based on the database and the information provided by the user. In various embodiments, the analysis module 1308 performs an algebraic topological analysis to identify structures and relationships within data and clusters of data. It will be appreciated that the analysis module 1308 may use parallel algorithms or use generalizations of various statistical techniques (e.g., generalizing the bootstrap to zig-zag methods) to increase the size of data sets that can be processed. The analysis is further discussed in FIG. 8 and FIG. 15. It will be appreciated that the analysis module 1308 is not limited to algebraic topological analysis but may perform any analysis.

The graph engine 1310 generates a non-visualized graph, a non-interactive visualization, an interactive visualization, or any combination using the output from the analysis module 320. The non-interactive visualization and interactive visualization allow the user to see all or part of the analysis graphically. The interactive visualization also allows the user to interact with the visualization. For example, the user may select portions of a graph from within the visualization to see and/or interact with the underlying data and/or underlying analysis. The user may then change the parameters of the analysis (e.g., change the metric, filter(s), or resolution(s)) which allows the user to visually identify relationships in the data that may be otherwise undetectable using prior means. The interactive visualization is further described in FIGS. 9-11.

The database storage 1312 is configured to store all or part of the database that is being accessed. In some embodiments, the database storage 1312 may store saved portions of the database. Further, the database storage 1312 may be used to store user preferences, parameters, and analysis output thereby allowing the user to perform many different functions on the database without losing previous work.

The placement engine 1314 determines a location of new data relative to nodes and/or data points in the graph or visualization. For example, after the graph is generated based on the originally received data, the input module 1302 and/or the placement engine 1314 may receive new data (e.g., new finance data). The placement engine 1314 may determine a location for the new data (e.g., one or more new data points) within the graph (or visualization). The placement engine 1314 may determine the location of the new data in any number of ways, including, for example, using metric distance associated with the originally received data or graph distances of the graph.

The distance module 1316 may determine distances between the new data point and any number of the originally received data points (e.g., of the originally received data points) using the metric(s) utilized by the analysis module 1308. In some embodiments, the distance module 1316 may determine graphical distances between the new data point and any number of the originally received data points and/or nodes in the graph or visualization.

The graph update engine 1318 may depict the location of the new data relative to the previously received visualization. The graph update engine 1318 may, in some embodiments, regenerate a visualization to depict the location of the new data.

The prediction module 1320 may receive a proximity value (e.g., from a user or user device 202) and select the closest data points, nodes, or any combination to the new data based on the location of the new data. The prediction module 1320 may further make assessments (e.g., statistical, analytical, or otherwise) to analyze the underlying data (e.g., originally received data) of the selected closest data points, nodes, new data, or any combination to make predictions.

The report module 1322 may generate tables, bar graphs, line graphs, charts, text, or any information regarding the assessment from the prediction module 1320. In some embodiments, the report module 1322 may provide “explains” or tables of the underlying data (e.g., the originally received data) related to the selected closest data points, nodes, new data, or any combination.

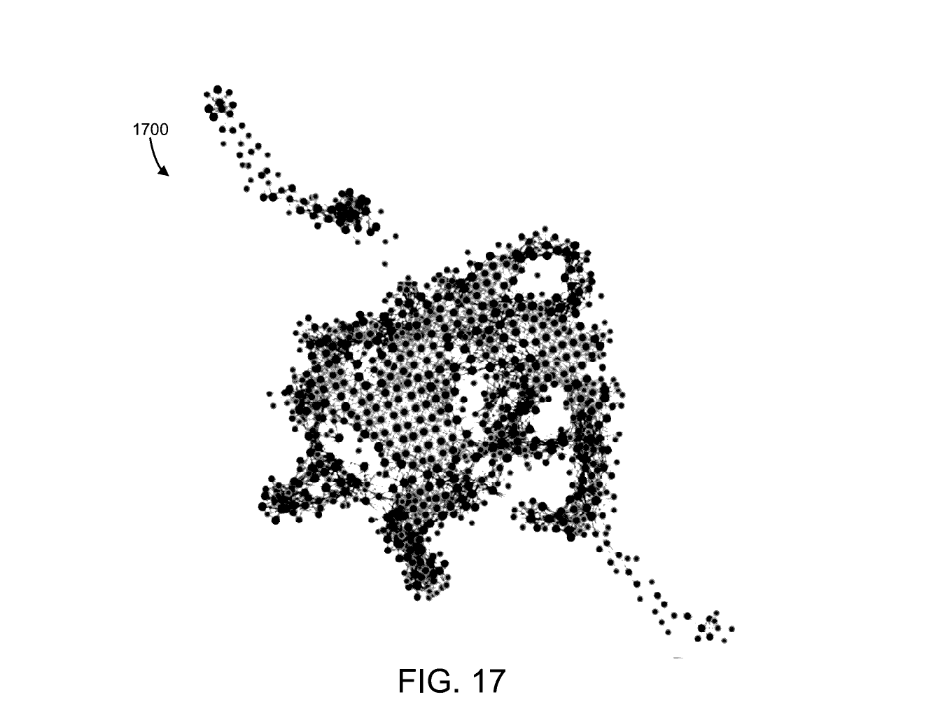

It will be appreciated that all or part of the analysis system 1300 may be at the user device 202a, the database storage server 206, another digital device, or any combination. The placement engine 1314, distance module 1316, graph update engine 1318, prediction module 1320, and report module 1322 are further discussed relative to FIGS. 17-29.

In various embodiments, systems and methods discussed herein may be implemented with one or more digital devices. In some examples, some embodiments discussed herein may be implemented by a computer program (instructions) executed by a processor. The computer program may provide a graphical user interface. Although such a computer program is discussed, it will be appreciated that embodiments may be performed using any of the following, either alone or in combination, including, but not limited to, a computer program, multiple computer programs, firmware, and/or hardware.

A module and/or engine may include any processor or combination of processors. In some examples, a module and/or engine may include or be a part of a processor, digital signal processor (DSP), application specific integrated circuit (ASIC), an integrated circuit, and/or the like. In various embodiments, the module and/or engine may be software or firmware.

The analysis system 1300 may forecast financial market information as discussed herein. The analysis system 1300 may produce derived data for downstream analysis including, but not limited to, asset returns, volatility estimates, changes in volatility, changes in liquidity, changes in interest rate levels, changes in unemployment rate levels, changes in GDP growth rate levels, and/or changes in macroeconomic indicators such as the ECRI Leading Index. Each such data point may be viewed as a tuple indicating the market regime during a particular time period. The time period may range from minutes, hours and days, to weeks, months and years.

Some embodiments may also include a system and method to produce derived information for forecasting purposes including, but not limited to, forward asset returns, cross-asset correlations, forward changes in volatility, and/or forward directional swings in asset prices, along with a system to perform Topological Data Analysis on the derived data in combination with new data points and build topological networks consisting of nodes and edges. Nodes may represent clusters of data points and edges may connect nodes that have data points in common.

Various embodiments may also include a system and method to query the topological network of market regime tuples and produce a set of market regimes that are most similar to the new data point (hereafter known as the “neighborhood set”) by extracting other data points within the same nodes that contain the new data point (hereafter known as the “containing nodes”). Additionally, this neighborhood set may be enlarged by the addition of market regime tuples corresponding to nodes that lie within N outbound links (N may equal 1) from the containing nodes. The neighborhood set may thus be systematically enlarged to build a sample set of market regime tuples to produce results that may be statistically significant.

Some embodiments may also include systems and methods to filter forecast data corresponding to the neighborhood set, compute statistical summaries of the filtered forecast data, and/or generate forecast estimates. Such estimation procedures may include computing medians of the forecast data, utilizing measures of the shape and structure of the probability distribution of the forecast data, also consuming discrete counts of positive and negative realizations of the forecast data. Additionally, if the forecast data includes cross-asset correlations, forecast estimation may include computing a median or arithmetic average across the realized cross-asset correlation matrices to produce a blended estimate.

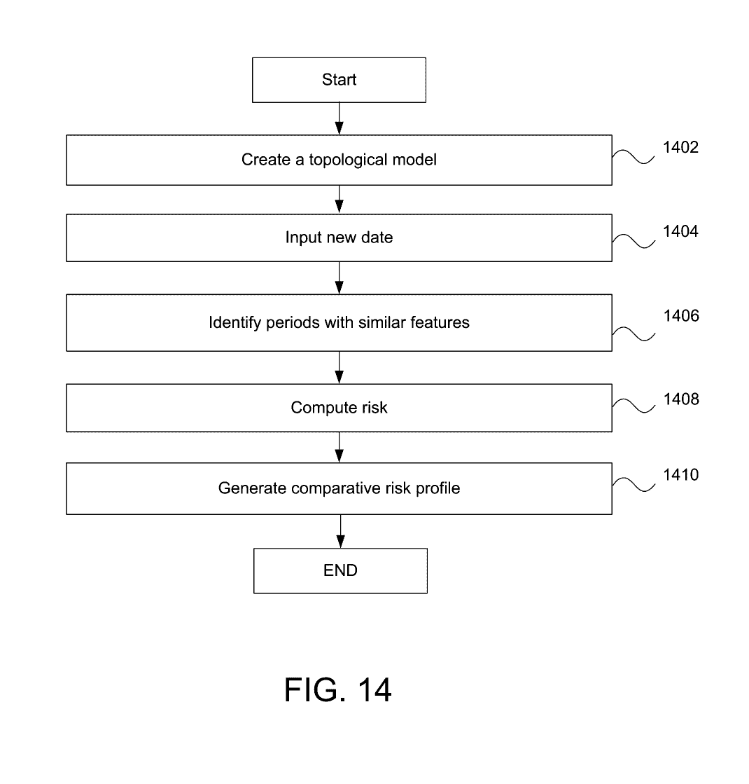

FIG. 14 depicts a flow chart for generating and using a TDA graph or model to create a comparative risk profile in some embodiments. In various embodiments, once the market regime visualization is generated using TDA, new data may be localized on the market regime visualization. The new data may be, for example, related to financial performance or other financial information of any number of assets, a class of assets (e.g., sectors of the economy, mutual funds, or the like), or any other information. Once localized relative to the market regime visualization, influencing nodes (e.g., those nodes closest to the new data on the visualization), data points, or any combination may be identified. The underlying data associated with the nodes and/or data points (e.g., data points related to the periods of time identified in the originally provided intermarket and/or macro-economic data) may be identified as influencing factors related to the new data. Further assessment regarding those influencing factors may be performed.

The market regime visualization may be interactive and/or searchable in real-time thereby potentially enabling extended analysis and providing speedy insight into markets and/or finance. Although the market regime visualization is described as a visualization herein, it will be appreciated that visualization is not necessary. For example, instead of a visualization, a market regime graph may be created that is not visualized. Further, the new data may be localized on the map and relationships identified without visualizing the graph. The underlying data may be provided in the form of reports, assessments, raw data, or any combination may be provided to a user or another model.

Influencing factors may be identified using the market regime visualization and predictions may be based on those factors as well as similar future influences. As a result, an expected model for particular intermarket and/or macro-economic conditions (e.g., when a particular market regime exists) may be generated that provides a predictor for future events related to the new data.

In step 1402, the analysis system 1300 may receive intermarket and/or macro-economic data from any number of sources and generate a topological model (e.g., generate a graph or visualization whereby nodes and edges denote relationships within the underlying intermarket and/or macro-economic data).

FIG. 15 is a flowchart for generating a market regime visualization utilizing intermarket and/or macro-economic data for any periods of time in some embodiments. In various embodiments, the processing of data and user-specified options is motivated by techniques from topology and, in some embodiments, algebraic topology. As discussed herein, these techniques may be robust and general. In one example, these techniques apply to almost any kind of data for which some qualitative idea of “closeness” or “similarity” exists. It will be appreciated that the implementation of techniques described herein may apply to any level of generality.

In various embodiments, a market regime visualization is generated using intermarket and/or macro-economic data linked to periodic (e.g., daily) measurements and/or reporting. The data may be based on any period of time including, for example, hours, days, weeks, months, years, decades, or any combination. In some embodiments, publicly available data sets (e.g., from reporting agencies or government bodies) may be integrated to construct the topological map visualizations of market regimes. It will be appreciated that any private, public, or combination of private and public data sets may be integrated to construct the topological map visualizations.

In step 1502, the input module 1302 of the analysis system 1300 receives intermarket and/or macro-economic data related to different periods of time or days from any number of sources including public reporting companies, private reporting companies, government bodies, agencies, or any combination. For example, the US Department of the Treasury may provide some of the data utilized in features of the received data. Intermarket data may include phenomena and factors that relate to multiple markets (e.g., one or more sectors of the economies, two or more markets, or the like). Macro-economic data may include economy-wide phenomena or factors that influence different economies. Examples may include inflation, price levels, rate of growth, national income, gross domestic product, and changes in unemployment.

The intermarket and/or macro-economic data, in one example, may be similar to data S as discussed with regard to step 802 of FIG. 8. The intermarket and/or macro-economic data may include ID fields that identify dates and data fields that are related to the market and financial information (e.g., prices and performance). Each row of the data may represent a data point associated with that date.

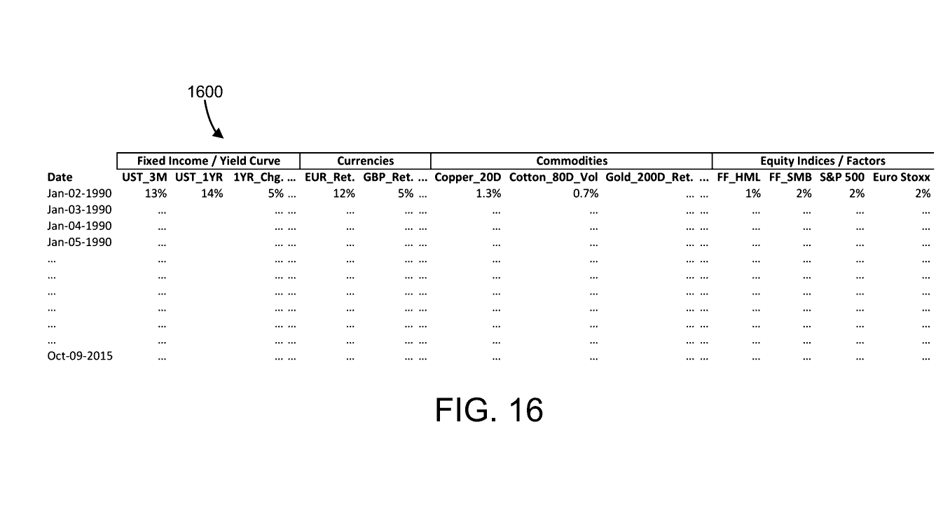

FIG. 16 depicts a rows and columns of example intermarket and/or macro-economic data that the analysis server may receive. Rows of the table 1600 may indicate one or more dates. Columns may be features identifying intermarket and/or macro-economic data. In this example, the intermarket and/or macro-economic data was sampled daily. The intermarket and/or macro-economic data may include any or all of the following, but is not limited to:
1) fixed income/yield curve of the US at 3 month, 1 year, and more;
2) currencies including the EUR Ret, GDBP Ret, and others;
3) commodities including Copper 20D, Cotton 80D Vol, Gold 200D Ret, and others;
4) Equity Indices/Factors including FF HML, FF SMB, S&P 500, Euro Stoxx; and
5) forward risk-returns for oil, gold, and similar assets.

Although FIG. 16 shows only a few features (e.g., categories of intermarket and/or macro-economic data), it will be appreciated that there may be any number of features. Further, although only a few sub columns are shown for each feature (e.g., fixed income/yield curve of the US at 3 month and 1 year), it will be appreciated that there may be any number of different types of measurements and indicators. For example, there may be tens, hundreds, thousands or more separate columns for different financial measurements and/or reporting related to a single day or period of time. It will be appreciated that there may be any number of data structures that contain any amount of intermarket and/or macro-economic data for any period. The data structure(s) may be utilized to generate any number of map graphs and/or visualizations.

In this example, the rows and columns of example intermarket and/or macro-economic data may include 25 years of market and economic data and over 150 variables sampled periodically (e.g., daily).

In steps 1504 and 1506, the input module 1302 and/or filter module 1304 may receive a filter selection and the analysis module 1308 may apply one or more of the selected filter function on the intermarket and/or macro-economic data to map the data to the reference space. In steps 1508 and 1510, the input module 1302 and/or resolution module 1306 receives a resolution selection and the analysis module 1308 may generate a cover to be used on the reference space using the selected resolution.

A user (e.g., data analyst or someone with less training) may select any number of filter(s), resolution, and gain. The resolution may be utilized to identify overlapping portions of the reference space (e.g., a cover of the reference space R).

As discussed herein, a cover of R may be a finite collection of open sets (in the metric of R) such that every point in R lies in at least one of these sets. In various examples, R is k-dimensional Euclidean space, where k is the number of filter functions. It will be appreciated that the cover of the reference space R may be controlled by the number of intervals and the overlap identified in the resolution (e.g., see FIG. 7). For example, the more intervals, the finer the resolution in S (e.g., the similarity space of the received biological data)—that is, the fewer points in each S(d), but the more similar (with respect to the filters) these points may be. The greater the overlap, the more times that clusters in S(d) may intersect clusters in S(e)—this means that more “relationships” between points may appear, but, in some embodiments, the greater the overlap, the more likely that accidental relationships may appear.

In one example, a user may select neighborhood lenses (e.g., 1 and 2). Resolution may include 150 and a gain of 4 which may be used for both lenses. It is appreciated that any lens(es), metric(s), resolution, or gain may be used.

In step 1512, the analysis system 1300 clusters the information of the cover in the reference space to partition S(d) using a metric. The metric may be received or selected by the user. In one example, the metric is norm. angle. The clusters may form the groupings (e.g., nodes or balls). Various cluster means may be used including, but not limited to, a single linkage, average linkage, complete linkage, or k-means method.

As discussed herein, in some embodiments, the analysis module 1308 may not cluster two points unless filter values are sufficiently “related” (recall that while normally related may mean “close,” the cover may impose a much more general relationship on the filter values, such as relating two points s and t if ref(s) and ref(t) are sufficiently close to the same circle in the plane where ref( )represents one or more filter functions). The output may be a simplicial complex, from which one can extract its 1-skeleton. The nodes of the complex may be partial clusters, (i.e., clusters constructed from subsets of S specified as the preimages of sets in the given covering of the reference space R).

In step 1514, the graph engine 1310 may generate the market regime visualization with nodes representing one or more data points from the intermarket and/or macro-economic data. For example, each member of a node may include any number of data points as members. In this example, a data point indicating financial information associated with a particular date may be a member of a node. Different nodes may contain different data points (e.g., for different periods of time). Nodes that share at least one data point (e.g., at least one row of the originally received data) may be connected by an edge. The analysis module 1308 may identify nodes which are associated with a subset of the partition elements of all of the S(d) for generating a potentially interactive visualization.

As discussed herein, for example, suppose that S={1, 2, 3, 4}, and the cover is C1, C2, C3. Suppose cover C1 contains {1, 4}, C2 contains {1,2}, and C3 contains {1,2,3,4}. If 1 and 2 are close enough to be clustered, and 3 and 4 are, but nothing else, then the clustering for S(1) may be {1},{4}, and for S(2) it may be {1,2}, and for S(3) it may be {1,2}, {3,4}. So the generated graph has, in this example, at most four nodes, given by the sets {1}, {4}, {1, 2}, and {3, 4} (note that {1, 2} appears in two different clusterings). Of the sets of points that are used, two nodes intersect provided that the associated node sets have a non-empty intersection (although this could easily be modified to allow users to require that the intersection is “large enough” either in absolute or relative terms).

As a result of clustering, financial data of a grouping within a node and financial data of a grouping of a connected node may share influences and similarities (e.g., similarities based on the intermarket and/or macro-economic data). As discussed herein, the analysis server may join clusters to identify edges (e.g., connecting lines between nodes). Clusters joined by edges (i.e., interconnections) share one or more members.

In step 1516, a display may display a market regime visualization with attributes based on the periods of time, financial outcomes, or both contained in the data structures. Any labels or annotations may be utilized based on information contained in the data structures. For example, outcomes, measurements, reporting, and the like may be used to label the visualization. In some embodiments, an analyst or other user may access the annotations or labels by interacting with the market regime visualization.

The resulting market regime visualization may reveal interactions and relationships that were obscured, untested, and/or previously not recognized.

FIG. 17 depicts an example market regime visualization 1700 in some embodiments. The market regime visualization 1700 represents a topological network of financial information. In various embodiments, the market regime visualization 1700 is created using market and macroeconomic data sampled on a daily basis starting from Jan. 1, 1990 to the current date.

These data series consist of market information, economic information, rates, curves (e.g., US treasury yield curves) and the like. Relationships that appear from the shape of the data (e.g., the layout and/or connections of nodes) may indicate influences that may exist for a market regime (e.g., when related market and macro-economic conditions impart influences).

While the image in FIG. 17 is depicted in black and white, it will be appreciated that the market regime visualization 1700 may include color, animations, and/or the like. The number of shared data points between two nodes may be represented in any number of ways including color of the interconnection, color of the groupings, size of the interconnection, size of the groupings, animations of the interconnection, animations of the groupings, brightness, or the like. Nodes and interconnections (e.g., edges) may be colored based on outcome, positive growth, negative growth, date, and/or any other information. In some embodiments, the number and/or identifiers of shared member data points of the two groupings may be available if the user interacts with the groupings (e.g., draws a box around the two groupings utilizing an input device such as a mouse or executes some other selection mechanism).

Returning to FIG. 14, in step 1404, the input module 1302 or the placement engine 13141 may receive new financial data from another digital device, a user, a remote source (e.g., reporting agency or government body), or any combination.

In step 1406, the placement engine 1314 and/or distance module 1316 server may identify data points (e.g., associated by dates) with similar features by or in order to localize the new financial data in the market regime visualization 1700.

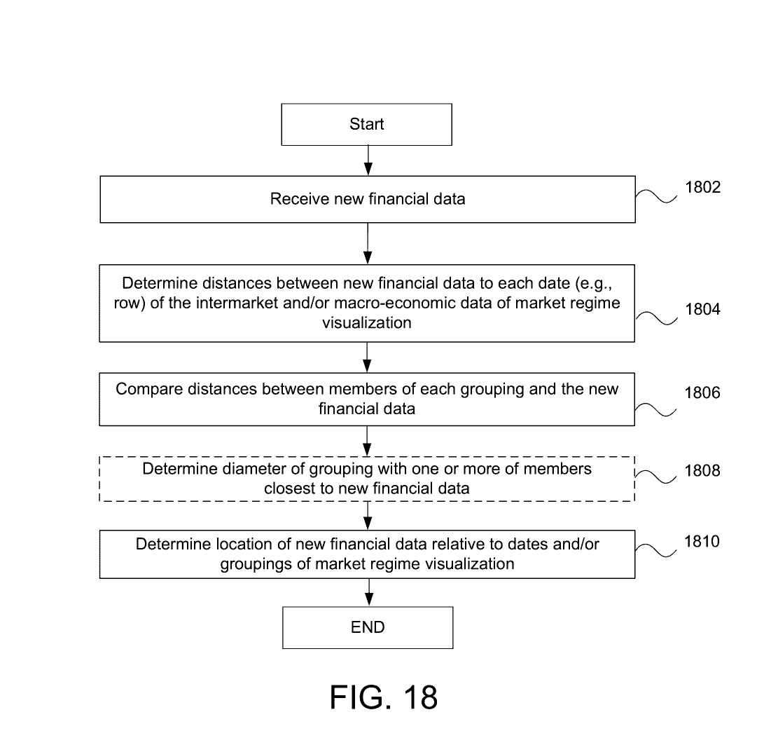

FIG. 18 is a flowchart for positioning new financial data relative to a market regime visualization in some embodiments. In step 1802, the input module 1302 or the placement engine 1315 receives new financial data from an analyst, user, reporting agency, government body, or the like. The new financial data may include a new data point related to any number of financial vehicles, sectors, economies, or any combination. In this example, new financial data may indicate financial results, measurements, analysis, or any combination for a specific period of time. The unit of time may be similar to that in the original data. For example, the new financial data may be associated with a date and the originally received intermarket and/or macro-economic data may also be organized by date.

In step 1804, the distance module 1316 determines distances between the originally received intermarket and/or macro-economic data of the market regime visualization 1700 and the new financial data. For example, the previous intermarket and/or macro-economic data that was utilized in the generation of the market regime visualization 1700 may be stored in mapped data structures. Distances may be determined between the new financial data and each of the previous the previous intermarket and/or macro-economic data in the mapped data structure (e.g., between vectors).

It will be appreciated that distances may be determined in any number of ways using any number of different metrics or functions. Distances may be determined between the intermarket and/or macro-economic data and the new data. For example, a distance may be determined between features (e.g., columns) of a date in the new data and each (or a subset) of the features of the originally received data. Distances may be determined between all (or a subset of) or any features of the new data and all or any of the features of the originally received data.

In various embodiments, a location of the new financial data on the market regime visualization 1700 may be determined relative to the other nodes or the intermarket and/or macro-economic data of the visualization utilizing the determined distances.

In step 1806, the distance module 1316 may compare distances between the members of each grouping to the distances determined for the new financial data. The new financial data may be located in the grouping of node members that are closest in distance to the new financial data. In some embodiments, the new financial data location may be determined to be within a grouping that contains the one or more members that are closest to the new financial data (even if other members of the grouping have longer distances with the new financial data). In some embodiments, this step is optional.

In various embodiments, a representative data point may be determined for each grouping. For example, one or more rows of the intermarket and/or macro-economic data may be identified by date. Some or all of the rows (e.g., information associated with the dates) associated with a grouping may be members of a node. The members (e.g., all or part of the information of the rows of data) may be averaged or otherwise combined to generate a representative of the grouping (e.g., the distances of or based on the intermarket and/or macro-economic data may be averaged or aggregated). The distance module 1316 may determine distances between the new financial data and the averaged or combined intermarket and/or macro-economic data of one or more representative members of one or more groupings. The placement engine 1314 may determine the location of the new financial data based on the distances. In some embodiments, once the closest distance between the new financial data and the representative member is found, distances may be determined between the new financial data and the individual members (e.g., rows of data) of the grouping associated with the closest representative member.

In optional step 1808, the distance module 1316 determines a diameter of the grouping with the one or more of the members that are closest to the new financial data (based on the determined distances). In one example, the diameters of the groupings of members closest to the new financial data are calculated. The diameter of the grouping may be a distance between two members who are the farthest from each other when compared to the distances between all members of the grouping. If the distance between the new financial data and the closest member of the grouping is less than the diameter of the grouping, the new financial data may be located within the grouping. If the distance between the new financial data and the closest member of the grouping is greater than the diameter of the grouping, the new financial data may be outside the grouping (e.g., a new grouping may be displayed on the market regime visualization with the new financial data as the single member of the new grouping). If the distance between the new financial data and the closest member of the grouping is equal to the diameter of the grouping, the new financial data may be placed within or outside the grouping.

It will be appreciated that the determination of the diameter of the grouping is not required in determining whether the new financial data location is within or outside of a grouping. In various embodiments, the distance module 1316 determines a distribution of distances between members and between members and the new financial data. The decision to locate the new financial data within or outside of the grouping may be based on the distribution. For example, if there is a gap in the distribution of distances, the new financial data may be separated from the grouping (e.g., as a new grouping). In some embodiments, if the gap is greater than a preexisting threshold (e.g., established by a user or previously programmed), the new financial data may be located in a new grouping that is placed relative to the grouping of the closest members. The process of calculating the distribution of distances of candidate member to determine whether there may be two or more groupings may be utilized in generation of the market regime visualization (e.g., in the process as described with regard to FIG. 15). It will be appreciated that there may be any number of ways to determine whether new financial data should be included within a grouping of other members.

In step 1810, the placement engine 1314 determines the location of the new financial data relative to the member and/or groupings of the market regime visualization. The new location may be relative to the determined distances between the new financial data and the previous data. The location of the new financial data may be part of a previously existing grouping or may form a new grouping. The graph update engine 1318 may depict the new financial data in the market regime visualization.

In some embodiments, the location of the new financial data with regard to the market regime visualization may be performed locally to a user. For example, the market regime visualization 1600 may be provided to the user (e.g., via digital device). The user may load the new financial data locally and the distances may be determined locally or via a cloud-based server. The location(s) associated with the new financial data may be overlaid on the previously existing market regime visualization either locally or remotely.

Those skilled in the art will appreciate that, in some embodiments, the previous state of the market regime visualization (e.g., market regime visualization 1700) may be retained or otherwise stored and a new market regime visualization generated utilizing the new financial data (e.g., in a method similar to that discussed with regard to FIG. 15). The graph update engine 1318, for example, may compare the newly generated map to the previous state and highlight differences thereby, in some embodiments, highlighting the location(s) associated with the new financial data.

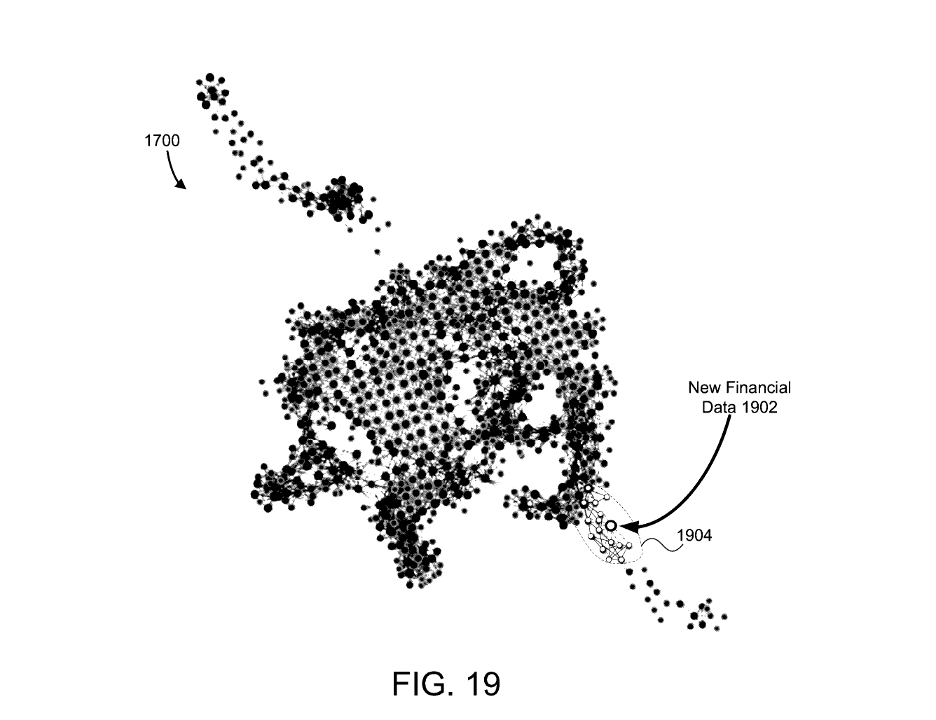

FIG. 19 is an example visualization displaying the market regime visualization 1700 as well as placement of the new financial data 1902 in some embodiments. In some embodiments, the new location of the new financial data is labeled or marked.

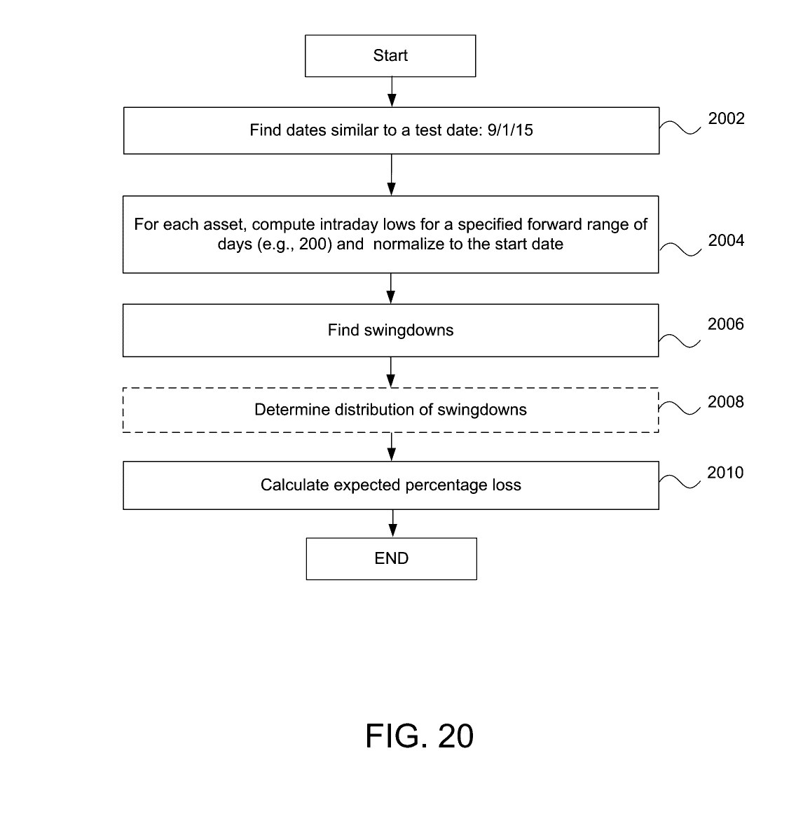

Returning to FIG. 14, the prediction module 1320 may identify data points with similar features in step 1406. Subsequently the prediction module 1320 may compute risk based on the identified data points. This process is further described with regard to FIG. 20.

In some embodiments, the latest data point may be located relative to the market regime graph and a standard deviation of the projected walk-forward returns is computed for points in the local neighborhood. Outcomes computed using this technique can be used to power asset allocation decisions.

Returning to FIG. 14, in step 1408, the prediction module 1320 may compute risk based on the identified datapoints with similar features. In step 1410, the prediction module 1320 generates a comparative risk profile associated with underlying assets, information, sectors, or the like associated with the new finance data.

FIG. 20 is a flow chart for identifying relationships based on placement of the new financial data in the market regime visualization and generating a prediction of expected percentage loss. In step 2002, the prediction module 1320 may find dates similar to a test date of the new financial data. In some embodiments, the input module 1302 or the prediction module 1320 receives a proximity value. The proximity value may be, for example, a positive integer or a distance. The proximity value may be provided by a user, analyst, another digital device, or the like. The proximity value may indicate a number of nodes closest to the location of the new financial data in the market regime visualization.

It will be appreciated that the nodes (e.g., the member data of the nodes) proximate to the new financial data in the market regime visualization (or non-visualized graph) may impact or influence on at least some of the new financial data. The proximity value may indicate the number of nodes to be identified that are closest to the location of the new financial data. FIG. 19 depicts a portion of the market regime visualization 1700 with the new financial data 1902 as well as the closest nodes to the new financial data 1902. The number of closest nodes to the new financial data (depicted in the selected portion 1904) is equal to the proximity value received by the input module 1302 and/or prediction module 1320.

The closest nodes to the new financial data 1902 may be identified in any number of ways. For example, distance may be defined as graphical distance in the market regime visualization. In another example, distance may be defined as metric distances (e.g., using a metric utilized in generation of the visualization as discussed with regard to FIG. 15). All or some distances may be determined between the new financial data and any or all of the nodes of the market regime visualization 1700. The closest number of nodes equal to the proximity value may be selected.

In various embodiments, the analysis system 1300 may generate a confidence or quality score of a prediction, forecast or model. The confidence or quality score may be based on a distribution of output measure of the similar data points (e.g., identified by similar dates). In one example, if the number of closest nodes to the new finance data is high (e.g., the proximity value is high) and the variance of results for similar points is small, then the confidence or quality score of the prediction may also be high.

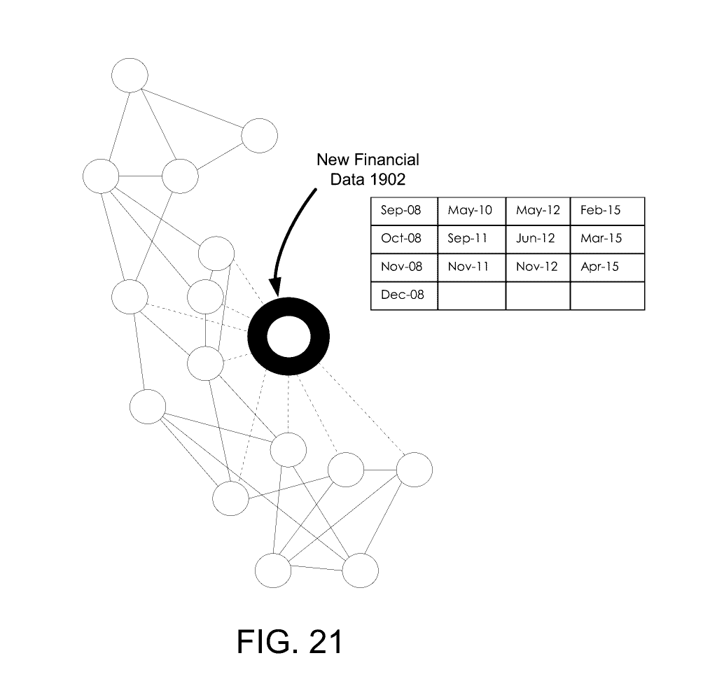

FIG. 21 depicts an example of a portion of the market regime visualization 1900 with the new financial data as well as the selected nodes closest to the new financial data. The selected nodes may include, in this example, data points from the originally received data identified by date. For this example, the dates include September 8, October 8, November 8, December 8, May 10, September 12, November 11, May 12, June 12, November 12, February 15, March 15, and April 15. It will be appreciated that there may be any number of data points selected based, at least in part, on distance from the new financial data.

Returning to FIG. 20, in step 2004, using the selected dates and related information, the prediction module 1320 may compute, for each asset to assess, intraday lows for a specified forward range of days (e.g., 200). It will be appreciated that many different assessments can be made. In this example, in order to test for expected percentage loss, intraday lows are computed for each asset. To this end, the prediction module 1320 may find swingdowns in step 2006 in order to determine a distribution of the found swingdowns in step 2008. Based on the selected data points closest to the data point(s) of the new financial data, the prediction module 1320 may compute the expected loss.

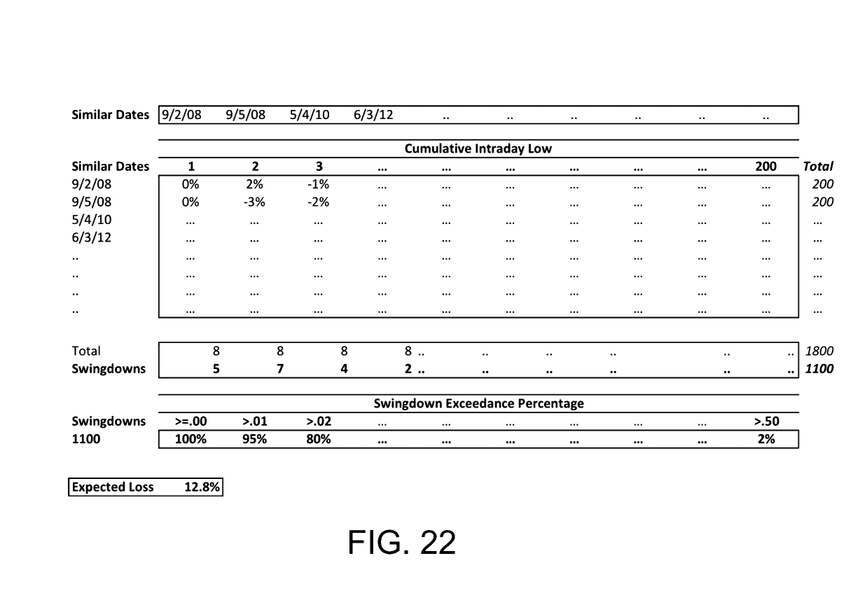

In some embodiments, the report module 1322 may generate a report as depicted in FIG. 22. FIG. 22 is an example report indicating the found similar dates (e.g., similar data points proximate to the data point(s) of the new financial data), the cumulative intraday low from the underlying data based on the similar dates for the specified forward range of days, total swingdowns for each of the specified forward range of days, and swingdown exceedance percentage.

Similar dates include 2 Sep. 2008, 5 Sep. 2008, 5 Apr. 2010, 3 Jun. 2012, and so on. Cumulative intraday low associated with each date may be listed. For example, the cumulative intraday low for 2 Sep. 2008 is 0%, 2%, −1%, and so on. The total swingdowns for each of the specified forward of days is listed as 5, 7, 4, 2, and so on. The swingdown exceedance percentage is identified for each of the days, which includes, for this example, 100%, 95%, 80%, and so on. The expected percentage loss is calculated based in part on the distribution of swingdowns. The example report in FIG. 22 indicates that the expected percentage loss is 12.8%.

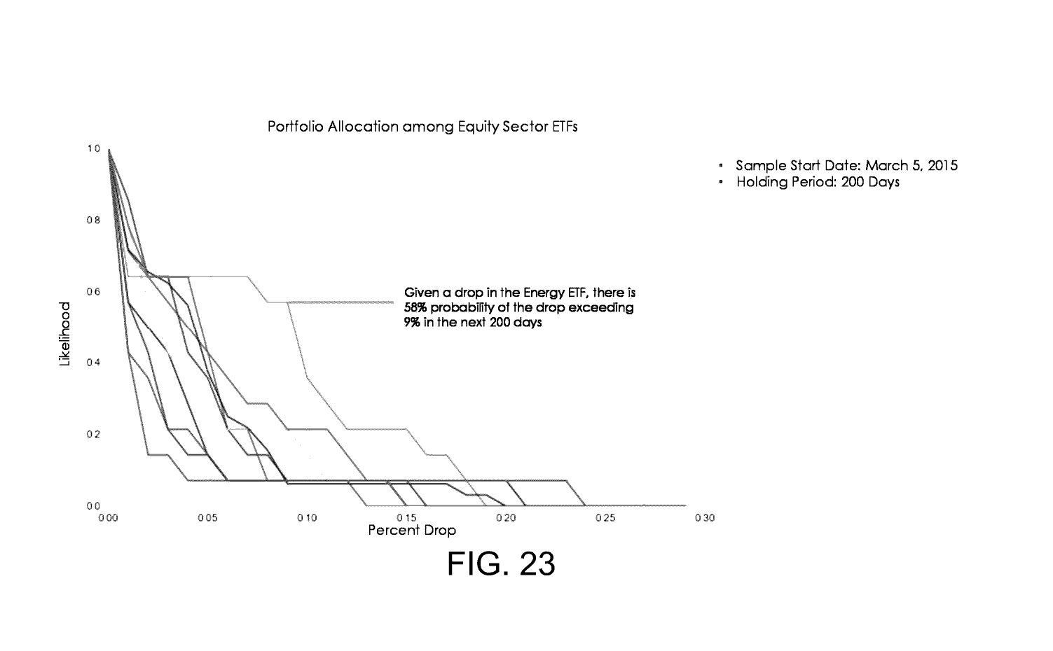

FIG. 23 is a graph indicating portfolio allocation among equity sector ETFs depicting measures of likelihood against percent drop. In some embodiments, the analysis system 1300 may receive intermarket and/or macro-economic data and generate a market regime graph based on the information, filters, resolution, gain, and metric as described herein. The analysis system 1300 may receive new financial data related to equity sector ETFs, determine placement of the new data points associated with the new financial data, and identify data points closest to placement. The analysis system may further generate prediction of expected percentage loss (e.g., using a similar process as described regarding FIG. 20). Subsequently, the analysis system 1300 may generate the graph of FIG. 23 to depict aspects of the prediction.

The graph of FIG. 23 may be generated based on the TDA process, localization of new finance data, selection of neighboring data points (e.g., members of nodes or nodes), and assessment of that selected neighboring data points. In the graph of FIG. 23, given a drop in the energy ETF, there appears to be a 58% probability of a drop exceeding 9% in the next 200 days. The sample start date is Mar. 5, 2015 and the holding period is 200 days.

Returning to FIG. 14, the prediction module 1320 may generate a comparative risk profile based on the risk computation. This comparative risk profile may be generated as a part of step 1410.

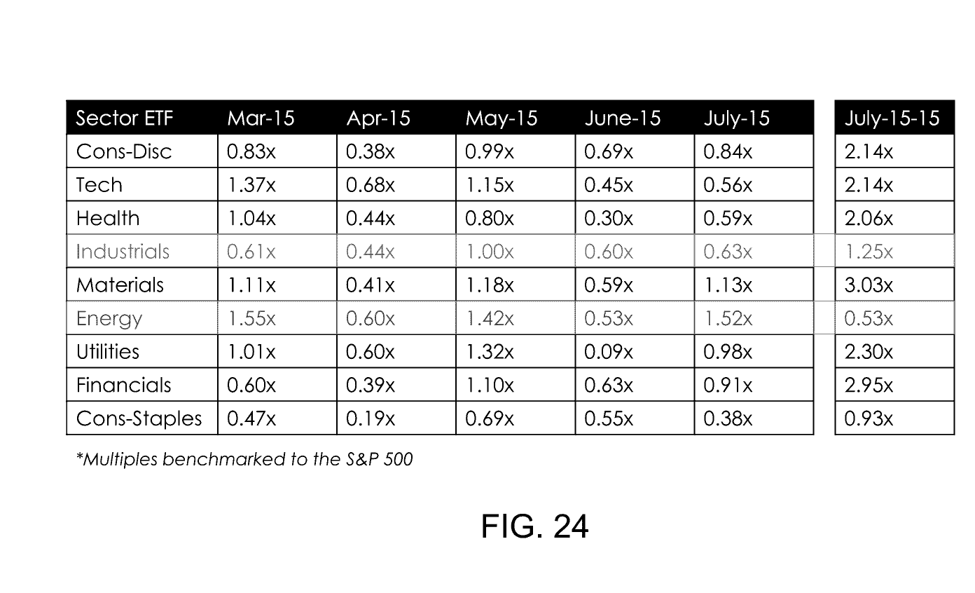

FIG. 24 is an example report of a comparative risk profile generated by the report module 1322 in some embodiments. The comparative risk profile may forecast forward risk for a portfolio. FIG. 24 depicts sector ETFs with multiple benchmarks (to the S&P 500) for the selected dates (e.g., the selected data points).

It will be appreciated that risk profiles, models, and predictions may be updated. In some embodiments, the risk profiles, models, and predictions may be periodically and/or continuously updated based on a cumulative sliding window (e.g., configured for example daily, weekly, monthly, quarterly, and/or the like).

In another example, systems and methods described herein may forecast financial market information. In some embodiments, the analysis system 1300 may receive a market and macro-economic dataset and generate a market regime graph using metrics, lenses, and resolution received from an analyst or user (e.g., via a digital device). The dataset may include sampled information taken on a daily basis or any periodic basis.

In this example, the analysis system 1300 may receive intermarket and/or macro-economic data sampled on a daily basis starting from Jan. 1, 1990 to the current date. These data series may include, but is not limited to:
(1) Markets. Equity indices (S&P 500, Russell 2000, Nikkei, Eurostoxx50), VIX, Commodities (Crude oil, natural gas, gold, copper, platinum, palladium, corn, wheat, soybean), Currencies (Euro, British Pound, Canadian Dollar, Japanese Yen, Australian Dollar, Swiss Franc)
(2) Economy: Unemployment rate, US dollar index, GDP, inflation, Leading index of indicators
(3) Rates: AAA and BAA corporate yields
(4) Curves: US Treasury yield curve

The analysis system 1302 may generate the market regime graph using TDA based on lens, metric, resolution, and gain received from one or more users. In this example, the lens may include neighborhood lenses 1 & 2, the metric may include norm angle, resolution may be 150, and gain may be 4 (for both lenses). It will be appreciated that many different lens(es), metrics, resolution, and gain(s) may be used.

In some embodiments, the resolution may be set using a heuristic. For example, the resolution module 1306 of the analysis system 1302 may generate the resolution as:

Resolution1*Resolution2=(# of rows)*Gain=Resolution̂2

Once the market regime graph is generated, the analysis system 1300 may predict directional signals of +1/−1 for S&P 500 and 9 US equity sectors—consumer discretionary, consumer staples, energy, financials, healthcare, industrials, materials, tech, and utilities. These signals are predictions of whether the underlying asset or asset class will go up (+1) or down (−1) in the next 1, 5, 10, 20, 50, 80 or 200 days. Other outcomes that may be computed include, for a given data point, finding and reporting the most similar time points in history and computing the key economic and market drivers for that localized region of the topological network. These outcomes are computed respectively from the row-sets defining the local neighborhood, and the top columns by Kolmogorov-Smirnoff statistics in comparison with the rest of the network (e.g., as similarly discussed regarding FIGS. 14, 18, and 20.

Features may be derived from the received data including, but not limited to:
(1) Markets: Generate (1) sliding window-returns over the last 1,5,10,20,50,80,200 days, (2) % changes in 20-day volatility over the last 5,10,20 days
(2) Rates: Generate level changes (*not* % changes) of the daily rate over the last 1,5,10,20,50,80,200 days
(3) Curves: For each tenor (3M, 6M, 1Y, etc.), generate level changes of the rate over the last 1,5, . . . , 200 days

Further, in some embodiments, for each outcome symbol, a signal may be generated by taking the sign of the median of the filtered distribution obtained from the neighborhood of the data point being examined (this is nearly always the data point representing today). The signal may indicate the direction of the underlying asset or asset class over one or more predetermined periods of time.

In various embodiments, similar systems and methods to that described herein and immediately above may identify business cycle turning points. The emphases in this example, however, is on predicting the future state of macroeconomic variables (outcomes) as opposed to market variables. Accordingly, this uses additional datasets that may include, for example, fundamental economic data such as: initial jobless claims, PMI Composite, Bloomberg Financial Conditions Index, capital utilization, balance of payments, housing starts, and the like. TDA analysis and market regime graph creation is the same or similar as that above regarding forecasting financial market information.

In various embodiments, liquidity profiles for algorithmic trading may be derived. The forecast data may include features such as changes in average daily volume over next M periods (for equities), changes in bid/ask spreads over next M periods (for currencies or OTC instruments), and changes in Amihud liquidity measure (for bonds). The forecast estimates of these features may be used to identify assets where average daily volume decreases, spreads widen, or other measures of liquidity decrease. Additionally, an embodiment of this system may include the production of a time-based liquidity profile in order to schedule the algorithmic execution of smaller chunks of trade orders that combine to produce large liquidity-seeking trades.

In an example, the outcome variable of interest is a volume profile that measures the per-minute traded volume of a chosen security (e.g. IBM stock) relative to the total traded volume of the security the previous trading day. There are 390 minutes in total, covering the time from 9:30 AM ET to 4 PM ET. Liquidity measures how easily an asset or security can be bought or sold in a market without affecting its price. A good proxy for liquidity is average traded volume per unit time. Liquidity forecasting may allow for control over trading costs and/or regulation compliance. Potential customers with an interest to control trading based on liquidity may include major investment banks, brokerages, large mutual funds, hedge funds, HFT firms, or entities that may trade millions of shares daily.

Inaccurate liquidity forecasts results in sub-optimal trade allocations that increase transaction costs and adversely impact market prices. Conventional approaches use narrow datasets and tend to break down when tackling high-dimensional datasets.

Systems and methods described herein (e.g., as discussed regarding FIGS. 13-24), may provide for comprehensive analysis, rapid pattern detection which may lead to superior liquidity forecasting models. For example, performing TDA on the intermarket and/or macro-economic data described herein and adding new financial data (e.g., trading information) provides for analysis of variables simultaneously and/or near simultaneously. Time horizon may be expanded beyond the most recent time periods (e.g., years of trading data). Time-periods that are similar to a period of interest may be uncovered from years of trading data. Surface key characteristics of similar trading days may be detected within high dimensional data. As a result, similar time-periods may be discovered to build more accurate liquidity forecasts and continuously update forecasts.

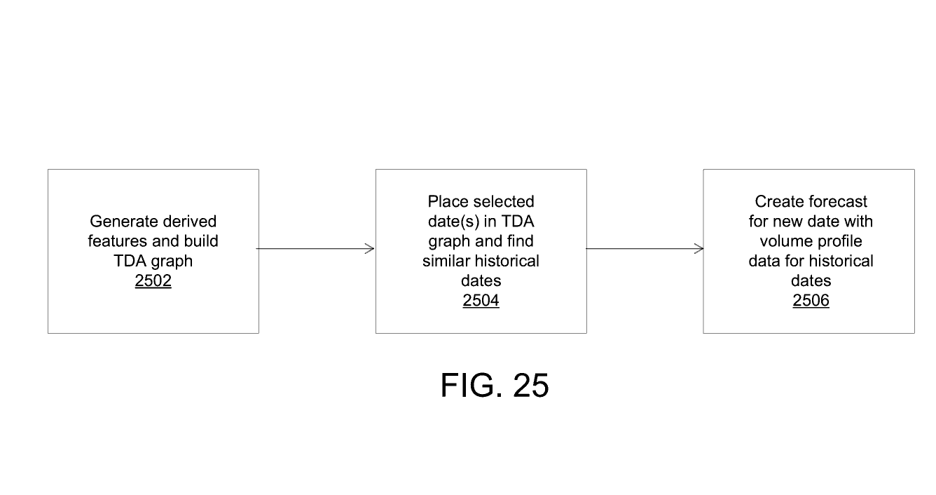

FIG. 25 is a flowchart for creating a forecast for new data with volume profile data for historical dates for liquidity in some embodiments. In step 2502, the analysis system 1300 generates derived features and builds a TDA graph (either visualized or unvisualized). In various embodiments, data is received from numerous sources. Additional information may be derived from the received data to include with the received data. It will be appreciated that all or some of the received data as well as derived features may be included in the original data set prior to TDA analysis.

Data may be received from any number of sources and may include equity indices, commodities, yield curves, currencies, and economic data. Equity indices may include, but is not limited to S&P 500, NASDAQ, Euro Stoxx, Nikkei, and the like. Commodities may include, but is not limited to crude oil, natural gas, gold, copper, corn, wheat, and the like. Yield curves may include, but is not limited to US treasury AAA corporate, BAA corporate, or the like. Currencies may include, but is not limited to Euro, British Pound, Canadian Dollar, Japanese Yen, Australian Dollar, US Dollar, or the like. Economic data may include, but is not limited to unemployment rate, US Dollar Index, leading indicators, or the like.

In addition to periodic sampling, additional information may be added to the data set including day of the week, and week of the year to capture seasonality effects that have an impact on liquidity of individual securities (e.g. Macy's stock is traded more heavily during the holiday season).

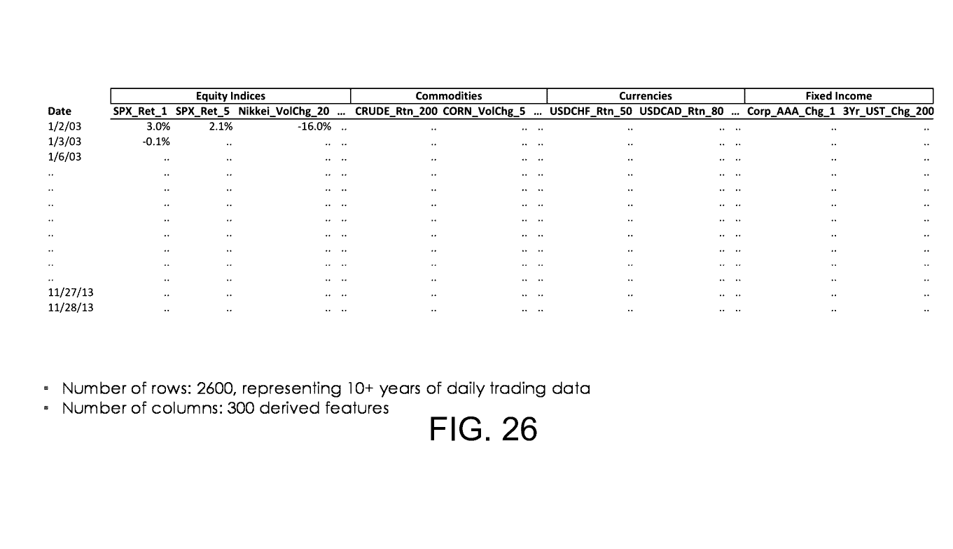

FIG. 26 depicts the data that the analysis system 1300 will utilize for TDA analysis in some embodiments. Each row may represent a data point associated with a particular date. Each of the 2600 rows may represent 10+ years of daily trading data. The number of columns may include any number (e.g., 300) derived features. The data is depicted in FIG. 26 as being structured with equity indices, commodities, currencies, and fixed income. The equity indices are divided among SPX_Ret_1, SPX-Ret_5, Nikkei VolChg_20, and so forth. The commodities indices may be divided among Crude_Rtn,_200, CORN_VolChg_5, and the like. Currencies indices are divided among USDCHF_Rtn_50, USDCAD_Rtn_80, and so forth. Fixed Income is divided among Corp_AAA_Chg_1, 3Yr_UST_Chg_200, and so forth.

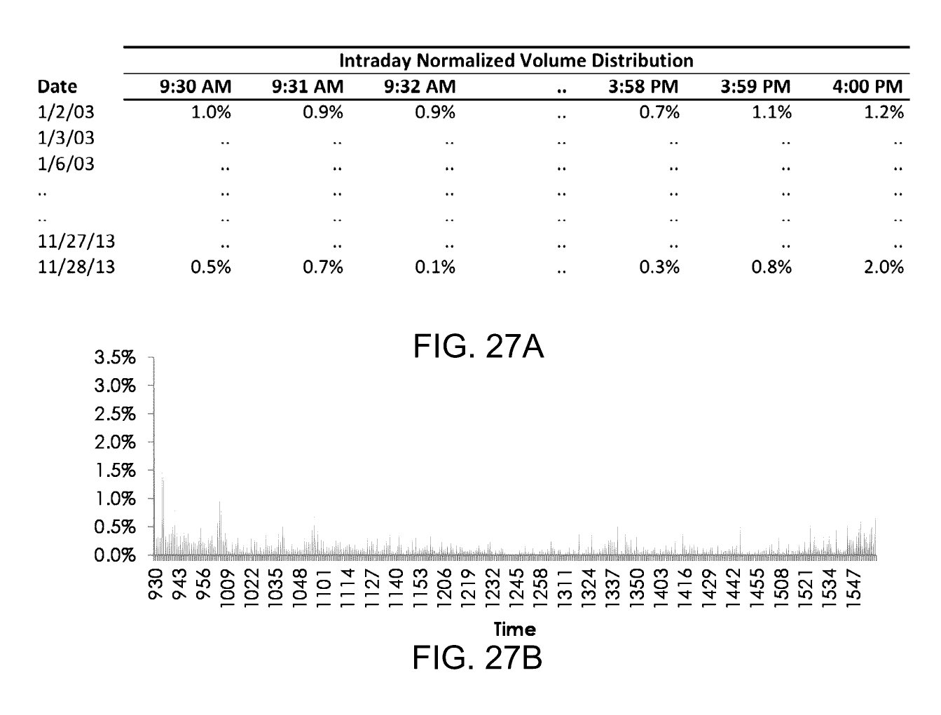

FIG. 27A depicts an example of an intraday normalized volume distribution. In FIG. 27A, the dates in order of trading days from Jan. 1, 2003 through Nov. 28, 2013. Time starts at the beginning of the trading day at 9:30 AM and proceeds through 1 minute increments. The chart in FIG. 27A indicates the percentage of trading volume for that day for each minute. Trading volume may be used as a proxy to measure liquidity. Volumes in each row may total 100%. Intraday 1 minute volume distribution shows peaks and valleys corresponding to spikes in order flow.

FIG. 27B depicts a bar chart for the example intraday normalized volume distribution. The bar chart provides for a range between 0-3.5% trading volume across time for a particular day. There may be any number of bar charts, each corresponding to a single day or multiple days.

The analysis system 1300 may build a market regime graph in a manner similar to that discussed regarding FIG. 15. For example, the input module 1302 of the analysis system 1300 may receive the data, one or more filter selections, a resolution selection, a gain selection, and a metric selection. The data may include, for example, 10 years of macro-economic and market data sampled daily from January 2003 through November 2013. The data may include 300 features for example. Selections of metrics, lenses, resolution, and gain may be similar to that discussed with regard to FIG. 15 and elsewhere herein. The graph engine 1310 may generate the market regime graph. The market regime graph (see visualization depicted in FIG. 17 for example) may include nodes that represent groups of dates (e.g., data points) with similar characteristics, edges that connect similar nodes that share member data points, and color may represent a high or low number of trading days (e.g., some nodes may be red indicating a high number of trading days while some nodes may be blue indicating a low number of trading days. The node colors may be part of a continuum of colors indicating relative number of trading days compared to other colors.

Returning to FIG. 25, in step 2504, the analysis system 1300 may select date(s) in the market regime graph and find similar historical dates. For example, the analysis system 1300 may receive one or more selected dates (e.g., data point identifiers), and the analysis system 1300 may determine a location for the one or more selected dates in the market regime graph. The analysis system 1300 may find similar historical dates (e.g., associated data points from the data set) by identifying a number (e.g., equal to a proximate value) of closest nodes and/or data points (e.g., based on metric distance or graph distance). Receiving the proximate value and determination of closest nodes and/or data points to one or more selected data points is discussed herein.

In one example, a user may provide a specific date in the market regime graph (e.g., Dec. 2, 2013) as well as a proximate value. The analysis system 1300 may identify a data point associated with the specific date. The analysis system 1300 may further identify a group of data points (or nodes) that are close to the selected data point (e.g., based on distance). The analysis system may provide information regarding the identified group of data points (e.g., identifying factors that are shared among the group or are unique for the group of data points relative to other date points in the market regime graph.

In some embodiments, the analysis system 1300 may select date(s) in the market regime graph and find similar historical dates. In this example, the analysis system 1300 may receive a new data point associated with a new date and may determine placement of the new data point relative to other nodes and/or data points in the market regime graph in a manner similar to that discussed regarding FIG. 18.

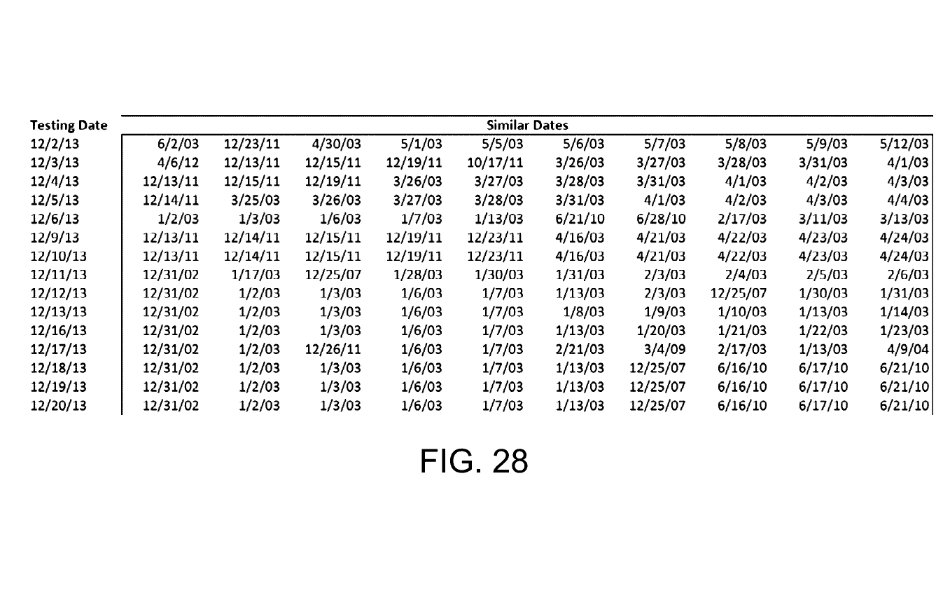

FIG. 28 is an example table indicating similar trading days that are similar to the date in the testing period (e.g. the one or more dates provided by the user). The table in FIG. 28 indicates testing dates from 2 Dec. 2013 through 20 Dec. 2013. The table indicates similar dates from the market regime graph. The similar dates identify data points that are similar (e.g., closest by metric distance or graphical distance) to the data point associated with the particular testing date. For example, 2 Dec. 2013 refers to a data point in the original data and in the market regime graph. The analysis system 1300 may determine the location of the data point associated with 2 Dec. 2013 in the market regime graph. The analysis system 1300 may further identify data points closest to the located data point associated with 2 Dec. 2013. The identified data points closest to the located data point include 2 Jun. 2003, 23 Dec. 2011, 30 Apr. 2003, 1 May 2003, 5 May 2003, 6 May 2003, 7 May 2003, 8 May 2008, 9 May 2003, and 12 May 2003. Each data point of the testing set (e.g., identified by the user by date) may be associated with a number of data points identified by date as depicted in the table of FIG. 28.

The similar dates may be used to assist in creating an individual liquidity forecasting model.

Returning to FIG. 25, in step 2506, the analysis system 1300 creates a forecast for the new date(s) with volume profile data for historical dates. In various embodiments, the analysis system 1300 formulates predictions based on the similar data points associated with each date in the testing set.

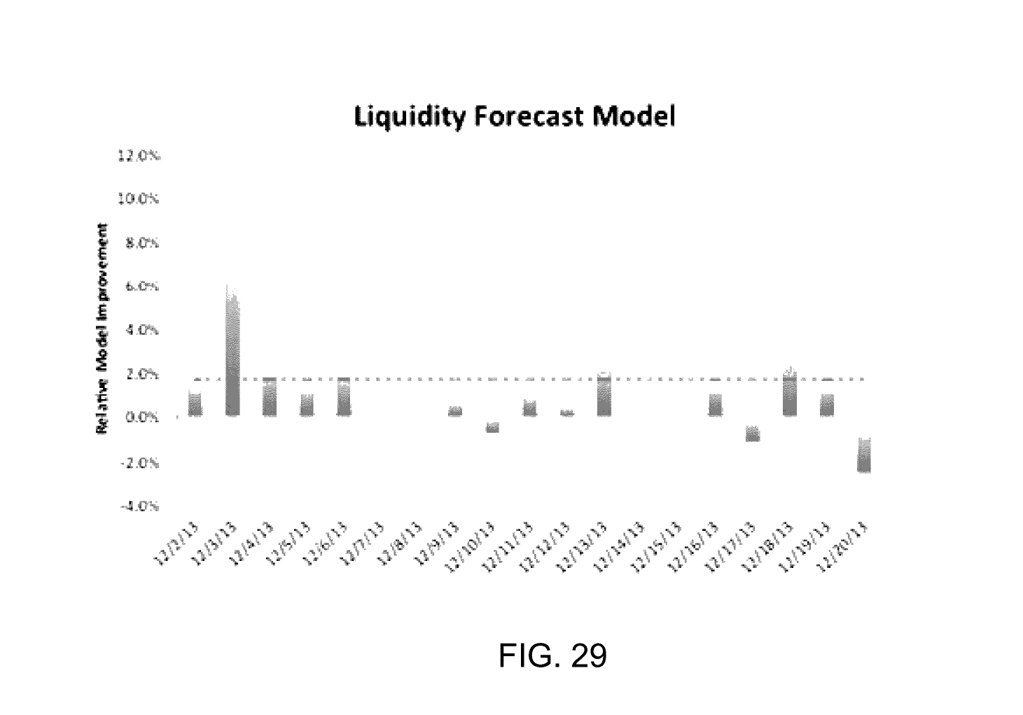

FIG. 29 depicts a liquidity forecast model generated by the analysis system 1300. The liquidity forecast model depicts relative model improvement and the testing dates. The liquidity profile may be based on the media volumes over the set of dates. A benchmark model may use the last 10 dates. The forecast model generated herein may use similar dates with a 10-year period, similarity modeled using 300+ variables. The forecast model generated herein may demonstrate higher accuracy relative to the benchmark model for the test period. In one example, the forecast model outperformed the benchmark on 80% of the trading days and has a media increase in accuracy.

The liquidity forecast may have a significant impact. In this example, transaction cost=execution cost+opportunity cost (assuming no overnight positions held and fixed price schedule at the median of 1 minute open high low close (OHCL) bar. To determine impact, the following equation may be utilized:

XΣₖ₌₀^{k=N}(Vₖ^{Model}−Vₖ^{Actual})*Pₖ
Where X=Total Order Size
K ranges from 0 to N intraday periods
Vₖ is the volume percentage at each time-interval
Pₖ is the media price at leach time interval.

Based on the information herein and total shares of 100,000, the cost per share based on the forecast model may be $19.26 for a total cost of $1,925,943. For the benchmark assuming the same total shares, the cost per share may be $20.74 with a total cost $2,074,230. The forecast model produces, in this example, a savings of $148,287 over the benchmark for 1 symbol for 1 day.

FIG. 30 is a block diagram of an example digital device 3000. The digital device 3000 comprises a processor 3002, a memory system 3004, a storage system 3006, a communication network interface 3008, an I/O interface 3010, and a display interface 3012 communicatively coupled to a bus 3014. The processor 3002 may be configured to execute executable instructions (e.g., programs). In some embodiments, the processor 3002 comprises circuitry or any processor capable of processing the executable instructions.

The memory system 3004 is any memory configured to store data. Some examples of the memory system 3004 are storage devices, such as RAM or ROM. The memory system 3004 can comprise the ram cache. In various embodiments, data is stored within the memory system 3004. The data within the memory system 3004 may be cleared or ultimately transferred to the storage system 3006.

The storage system 3006 is any storage configured to retrieve and store data. Some examples of the storage system 3006 are flash drives, hard drives, optical drives, and/or magnetic tape. In some embodiments, the digital device 3000 includes a memory system 3004 in the form of RAM and a storage system 3006 in the form of flash data. Both the memory system 3004 and the storage system 3006 comprise computer readable media which may store instructions or programs that are executable by a computer processor including the processor 3002.

The communication network interface (com. network interface) 3008 can be coupled to a communication network (e.g., communication network 204) via the link 3016. The communication network interface 3008 may support communication over an Ethernet connection, a serial connection, a parallel connection, or an ATA connection, for example. The communication network interface 3008 may also support wireless communication (e.g., 3002.11 a/b/g/n, WiMax). It will be apparent to those skilled in the art that the communication network interface 3008 can support many wired and wireless standards.

The optional input/output (I/O) interface 3010 is any device that receives input from the user and output data. The optional display interface 3012 is any device that may be configured to output graphics and data to a display. In one example, the display interface 3012 is a graphics adapter.

It will be appreciated by those skilled in the art that the hardware elements of the digital device 3000 are not limited to those depicted in FIG. 30. A digital device 3000 may comprise more or less hardware elements than those depicted. Further, hardware elements may share functionality and still be within various embodiments described herein. In one example, encoding and/or decoding may be performed by the processor 3002 and/or a co-processor located on a GPU.

The above-described functions and components can be comprised of instructions that are stored on a storage medium (e.g., a computer readable storage medium). The instructions can be retrieved and executed by a processor. Some examples of instructions are software, program code, and firmware. Some examples of storage medium are memory devices, tape, disks, integrated circuits, and servers. The instructions are operational when executed by the processor (e.g., a data processing device) to direct the processor to operate in accord with embodiments of the present invention. Those skilled in the art are familiar with instructions, processor(s), and storage medium.

The present invention has been described above with reference to example embodiments. It will be apparent to those skilled in the art that various modifications may be made and other embodiments can be used without departing from the broader scope of the invention. Therefore, these and other variations upon the example embodiments are intended to be covered by the present invention.

What is claimed is:

1. A non-transitory computer readable medium including executable instructions, the instructions being executable by a processor to perform a method, the method comprising:
receiving a data set;
generating a topological representation using the received data set and topological data analysis, the topological representation being generated using at least one metric-lens combination of a subset of metric-lens combinations, the topological representation including a plurality of nodes, each of the nodes having one or more data points from the data set as members, at least two nodes of the plurality of nodes being connected by an edge if the at least two nodes share at least one data point from the data set as members;
receiving a new data point;
determining distances between the new data point and at least some of the one or more data points from the data set;
locating the new data point in a location relative to one or more of the nodes in the topological representation using the distances between the new data point and the at least some of the one or more data points from the data set;
identifying a subset of the data points closest to the location of the new data point;
comparing the subset of the data points to at least some information regarding the new data point to identify a regime associated with the new data point; and
generating a report indicating a model associating factors associated with the subset of the data points with the new data point for predicting future outcomes.

2. The non-transitory computer readable medium of claim 1 wherein the topological representation is a visualization depicting the plurality of nodes and the edge.

3. The non-transitory computer readable medium of claim 1 wherein each of the one or more data points from the data set are identified by a date indicating a plurality of conditions associated with that date.

4. The non-transitory computer readable medium of claim 3 wherein the new data point is associated with a new date and the subset of the data points closests to the location for the new data point include at least one similar condition of the plurality of conditions.

5. The non-transitory computer readable medium of claim 3 wherein the model predicts an outcome associated with information regarding the new data point when the least one similar condition of the plurality of conditions recurs.

6. The non-transitory computer readable medium of claim 1 wherein the distances between the new data point and the at least some of the one or more data points from the data set is based on a metric from the at least one metric-lens combination.

7. The non-transitory computer readable medium of claim 1 wherein the distances between the new data point and the at least some of the one or more data points from the data set is based on a graphical distance of the topological representation.

8. The non-transitory computer readable medium of claim 1 wherein a number of the subset of the data points closest to the new data point is based on a proximity value.

9. The non-transitory computer readable medium of claim 8 wherein the proximity value is received from a digital device.

10. The non-transitory computer readable medium of claim 1 wherein information associated with the new data point and the number of the subset of the data points closest to the new data point is based on a proximity value is analyzed using statistical measures to determine correlations.

11. A method comprising:
receiving a data set;
generating a topological representation using the received data set and topological data analysis, the topological representation being generated using at least one metric-lens combination of a subset of metric-lens combinations, the topological representation including a plurality of nodes, each of the nodes having one or more data points from the data set as members, at least two nodes of the plurality of nodes being connected by an edge if the at least two nodes share at least one data point from the data set as members;
receiving a new data point;
determining distances between the new data point and at least some of the one or more data points from the data set;
locating the new data point in a location relative to one or more of the nodes in the topological representation using the distances between the new data point and the at least some of the one or more data points from the data set;
identifying a subset of the data points closest to the location of the new data point;
comparing the subset of the data points to at least some information regarding the new data point to identify a regime associated with the new data point; and
generating a report indicating a model associating factors associated with the subset of the data points with the new data point for predicting future outcomes.

12. The method of claim 11 wherein the topological representation is a visualization depicting the plurality of nodes and the edge.

13. The method of claim 11 wherein each of the one or more data points from the data set are identified by a date indicating a plurality of conditions associated with that date.

14. The method of claim 13 wherein the new data point is associated with a new date and the subset of the data points closests to the location for the new data point include at least one similar condition of the plurality of conditions.

15. The method of claim 13 wherein the model predicts an outcome associated with information regarding the new data point when the least one similar condition of the plurality of conditions recurs.

16. The method of claim 1 wherein the distances between the new data point and the at least some of the one or more data points from the data set is based on a metric from the at least one metric-lens combination.

17. The method of claim 1 wherein the distances between the new data point and the at least some of the one or more data points from the data set is based on a graphical distance of the topological representation.

18. The method of claim 1 wherein a number of the subset of the data points closest to the new data point is based on a proximity value.

19. The method of claim 8 wherein the proximity value is received from a digital device.

20. The method of claim 1 wherein information associated with the new data point and the number of the subset of the data points closest to the new data point is based on a proximity value is analyzed using statistical measures to determine correlations.

21. A system comprising:
a processor;
a memory including instructions to configure the processor to:
receive a data set;
generate a topological representation using the received data set and topological data analysis, the topological representation being generated using at least one metric-lens combination of a subset of metric-lens combinations, the topological representation including a plurality of nodes, each of the nodes having one or more data points from the data set as members, at least two nodes of the plurality of nodes being connected by an edge if the at least two nodes share at least one data point from the data set as members;
receive a new data point;
determining distances between the new data point and at least some of the one or more data points from the data set;
locate the new data point in a location relative to one or more of the nodes in the topological representation using the distances between the new data point and the at least some of the one or more data points from the data set;
identify a subset of the data points closest to the location of the new data point;
compare the subset of the data points to at least some information regarding the new data point to identify a regime associated with the new data point; and
generate a report indicating a model associating factors associated with the subset of the data points with the new data point for predicting future outcomes.
